SEQUENCE LISTING (22 sequences)

SEQ ID NO: 1 - protein, 6 aa, synthetic construct
  REGION 1..6: note = Synthetic peptide
  VARIANT 1..6: note = Residues 1-6 are repeated 5 to 15 times
GAGAGS

SEQ ID NO: 2 - protein, 30 aa, synthetic construct
  REGION 1..30: note = Synthetic peptide
  VARIANT 2: note = Xaa is V, I, or A
  VARIANT 4: note = Xaa is V, I, or A
  VARIANT 6: note = Xaa is V, I, or A
  VARIANT 8: note = Xaa is V, I, or A
  VARIANT 10: note = Xaa is V, I, or A
  VARIANT 11..30: note = Optionally absent.
  VARIANT 12: note = Xaa is V, I, or A
  VARIANT 14: note = Xaa is V, I, or A
  VARIANT 16: note = Xaa is V, I, or A
  VARIANT 18: note = Xaa is V, I, or A
  VARIANT 20: note = Xaa is V, I, or A
  VARIANT 22: note = Xaa is V, I, or A
  VARIANT 24: note = Xaa is V, I, or A
  VARIANT 26: note = Xaa is V, I, or A
  VARIANT 28: note = Xaa is V, I, or A
  VARIANT 30: note = Xaa is V, I, or A
GXGXGXGXGXGXGXGXGXGXGXGXGXGXGX

SEQ ID NO: 3 - protein, 4 aa, synthetic construct
  REGION 1..4: note = Synthetic peptide
GAAS

SEQ ID NO: 4-5 - skipped (2 entries)

SEQ ID NO: 6 - protein, 6 aa, synthetic construct
  REGION 1..6: note = Synthetic peptide
GLGGLG

SEQ ID NO: 7 - protein, 6 aa, synthetic construct
  REGION 1..6: note = Synthetic peptide
  VARIANT 2: note = Xaa is L, I, V, or P
  VARIANT 5: note = Xaa is L, I, V, or P
GXGGXG

SEQ ID NO: 8 - protein, 6 aa, synthetic construct
  REGION 1..6: note = Synthetic peptide
  VARIANT 3..5: note = Residues 3-5 are repeated 1 to 4 times.
  VARIANT 5: note = Xaa is Y, V, S, or A
GPGGXY

SEQ ID NO: 9 - protein, 5 aa, synthetic construct
  REGION 1..5: note = Synthetic peptide
  VARIANT 1..5: note = Residues 1-5 are repeated 1 to 10 times.
GRGGA

SEQ ID NO: 10 - protein, 30 aa, synthetic construct
  REGION 1..30: note = Synthetic peptide
  VARIANT 3: note = Xaa is A, T, V, or S
  VARIANT 4..30: note = Optionally absent.
  VARIANT 6: note = Xaa is A, T, V, or S
  VARIANT 9: note = Xaa is A, T, V, or S
  VARIANT 12: note = Xaa is A, T, V, or S
  VARIANT 15: note = Xaa is A, T, V, or S
  VARIANT 18: note = Xaa is A, T, V, or S
  VARIANT 21: note = Xaa is A, T, V, or S
  VARIANT 24: note = Xaa is A, T, V, or S
  VARIANT 27: note = Xaa is A, T, V, or S
  VARIANT 30: note = Xaa is A, T, V, or S
GGXGGXGGXGGXGGXGGXGGXGGXGGXGGX

SEQ ID NO: 11 - protein, 7 aa, synthetic construct
  REGION 1..7: note = Synthetic peptide
  VARIANT 4: note = Residue is repeated 6 to 7 times
GAGAGGA

SEQ ID NO: 12 - protein, 8 aa, synthetic construct
  REGION 1..8: note = Synthetic peptide
  VARIANT 3: note = Xaa is Q, Y, L, A, S, or R
  VARIANT 5: note = Xaa is Q, Y, L, A, S, or R
  VARIANT 7: note = Xaa is Q, Y, L, A, S, or R
  VARIANT 8: note = Xaa is Q, Y, L, A, S, or R
GGXGXGXX

SEQ ID NO: 13 - protein, 16 aa, synthetic construct
  REGION 1..16: note = Synthetic peptide
TGSSGFGPYVNGGYSG

SEQ ID NO: 14 - protein, 8 aa, synthetic construct
  REGION 1..8: note = Synthetic peptide
YEYAWSSE

SEQ ID NO: 15 - protein, 7 aa, synthetic construct
  REGION 1..7: note = Synthetic peptide
SDFGTGS

SEQ ID NO: 16 - protein, 7 aa, synthetic construct
  REGION 1..7: note = Synthetic peptide
RRAGYDR

SEQ ID NO: 17 - protein, 8 aa, synthetic construct
  REGION 1..8: note = Synthetic peptide
EVIVIDDR

SEQ ID NO: 18 - protein, 18 aa, synthetic construct
  REGION 1..18: note = Synthetic peptide
TTIIEDLDITIDGADGPI

SEQ ID NO: 19 - protein, 8 aa, synthetic construct
  REGION 1..8: note = Synthetic peptide
TISEELTI

SEQ ID NO: 20 - protein, 12 aa, synthetic construct
  REGION 1..12: note = Synthetic peptide
GCGAGAGCGAGA

SEQ ID NO: 21 - protein, 10 aa, synthetic construct
  REGION 1..10: note = Synthetic peptide
GAGAGSGAAS

SEQ ID NO: 22 - protein, 28 aa, synthetic construct
  REGION 1..28: note = Synthetic peptide
ALKAQSEEEAASARANAATAATQSALEG

(19) United States
(12) Patent Application Publication
(10) Pub. No.: US 2024/0104583 A1
(43) Pub. Date: Mar. 28, 2024

(54) Integrating Biopolymer Design with Physical Unclonable Functions for Anticounterfeiting and Product Traceability

(71) Applicant: Massachusetts Institute of Technology, Cambridge, MA (US)

(72) Inventors: Anantha Chandrakasan, Cambridge, MA (US); Benedetto Marelli, Cambridge, MA (US); Hui Sun, Cambridge, MA (US); Saurav Maji, Cambridge, MA (US)

(21) Appl. No.: 18/358,271

(22) Filed: Jul. 25, 2023

Related U.S. Application Data
(60) Provisional application No. 63/377,156, filed on Sep. 26, 2022.

(51) Int. Cl. G06Q 30/018; G06Q 50/02; H04L 9/32

(52) U.S. Cl. CPC G06Q 30/0185; G06Q 50/02; H04L 9/3278

(57) ABSTRACT

Compositions are provided that include a first product with a physical unclonable function (PUF) tag including silk particles conformably and directly attached to the first product, wherein the PUF tag cannot be reattached to a second product once removed from the first product.

### CROSS REFERENCE

This application claims priority to U.S. Provisional Patent Application Ser. No. 63/377,156 filed Sep. 26, 2022, incorporated by reference herein in its entirety.

### STATEMENT OF GOVERNMENT SUPPORT

This invention was made with government support under grant numbers N000142112402 and N000141912317 awarded by the Office of Naval Research and grant number CMMI-1752172 awarded by the National Science Foundation, The government has certain rights in the invention.

### REFERENCE TO AN ELECTRONIC SEQUENCE LISTING

The instant application contains an electronic Sequence Listing that has been submitted electronically and is hereby incorporated by reference in its entirety. The sequence listing was created on Jul. 31, 2023, is named “22-1158-US SubSequence-Listing.xml” and is 40,722 bytes in size.

### BACKGROUND

Counterfeiting has been a global, long-lasting, and unsolved issue that permeates virtually every field of our society from the luxury goods industry to pharmaceuticals. Existing anti-counterfeiting technologies are based on deterministic encoding mechanism that possesses inherent vulnerability to various cloning attacks.

### SUMMARY

In one aspect, the disclosure provides compositions comprising a first product, wherein the first product comprises a physical unclonable function (PUF) tag comprising silk particles conformably and directly attached to the first product, wherein the PUF tag cannot be reattached to a second product once removed from the first product. In various embodiments, the first product comprises an agricultural product, a solid product for oral ingestion, a packaged product wherein the PUF tag is conformably and directly attached to the package, and an injectable product.

In one embodiment, the PUF tag is directly attached to the first product via non-covalent bonding. In another embodiment, the silk particles comprise microparticles and/or nanoparticles. In a further embodiment, the PUF tag does not maintain its intactness and/or its adhesiveness when removed from the first product.

In one embodiment, the silk particles comprise silk fibroin having an average molecular weight of between about 5 kD and about 400 kD. In another embodiment, the silk particles comprise or consist of crystalline silk. In a further embodiment, the PUF is biodegradable, and/or is edible.

In one embodiment, the disclosure comprises a composition comprising a plurality of the first products of any embodiment disclosed herein. In another embodiment, the composition further comprises additional first products that do not comprise a PUF tag. In a further embodiment, the plurality of first products comprise a plurality of molecularly distinct PUF tags comprising different silk polymorphs. In one embodiment, the plurality of molecularly distinct PUF tags comprise colored inorganics having random and visually distinct patterns in the plurality of PUF tags. In another embodiment, the colored inorganics are selected from the group consisting of colored salts (including but not limited to FeCl₃ CuCl₂, CuSO₄, MnCl₂, FeSO₄, and combinations thereof), pigments, particles of photonic crystals, and/or colored microparticles, and combinations thereof In a further embodiment, the plurality of PUF tags have distinct Raman spectroscopy spectra. In another embodiment, the silk particles comprise a marked region to standardize Raman mapping and/or optical imaging.

In another aspect, the disclosure provides methods for preparing the composition of any embodiment herein, comprising

(a) templated crystallization of silk fibroin into different polymorphs by mixing (i) a first solution of silk fibroin with (ii) a solution of peptides that possess the following properties: (i) capable of forming ordered supramolecular nanoassemblies; (iii) capable of binding to silk molecules through non-covalent interactions; and (iv) sharing a similar isoelectric point and pH stability to that of silk fibroin, to form a mixture;

(b) incubating the mixture to form silk-peptide microparticles in the mixture ;

(c) freeze-drying the mixture comprising silk-peptide microparticles to obtain lyophilized silk powders;

(d) grinding the silk powders to obtain silk microparticles;

(e) drop casting a suspension composed of the silk microparticles and amorphous silk molecules on the first products to form PUF tags conformably and directly attached to the first products.

In one embodiment, the amorphous silk molecules comprise amorphous silk microparticles. In another embodiment, the amorphous silk microparticles comprise silk fibroin comprising β-turns, helices and β-pleated sheets. In a further embodiment, step (b) comprises an initial formation of silk-peptide nanocomplexes and their subsequent growth to micrometer sizes as characterized by a gradual increase in solution turbidity. In one embodiment, step (c) comprises freeze-drying after templated crystallization reaches equilibrium. In another embodiment, step (e) comprises drop casting a suspension composed of spectrally distinct silk MPs and amorphous silk molecules at a mass ratio in the range of 2:1 to 3:1 in the final suspension, followed by air drying.

In another embodiment, the disclosure provides methods for analyzing the composition of any embodiment herein wherein the PUF tags comprise colored silk-inorganics exhibiting random and visually distinct patterns, comprising detecting the random and distinct visual patterns. In one embodiment, the detecting comprises generating a PUF code using a pocket microscope connected to a smart phone and processed by digitizing to a binary cryptographic key. In another embodiment, the inorganic comprises colored salts (including but not limited to FeCl₃ CuCl₂, CuSO₄, MnCl₂, FeSO₄, and combinations thereof), pigments, particles of photonic crystals, and/or colored microparticles, and combinations thereof.

### DESCRIPTION OF THE FIGURES

FIG. 1. Engineering spectrally and visually distinct silk MPs for fabrication of conformable tags on seeds. a, Silk MPs #1 were spray dried from a regenerated silk fibroin solution followed by water annealing of the particles to render them water-insoluble. b, Silk MPs #2-#4 were fabricated through templated crystallization of amorphous silk on three different peptide seeds ((GCGAGA)₂ is SEQ ID NO:20; GAGAGSGAAS is SEQ ID NO:21; and HBSP refers to honeybee silk peptide). c, The four silk MPs of different polymorphs show distinct Raman spectra. d, Schematic of the fabrication of a spectral PUF tag through drop casting a mixture of spectrally distinct silk MPs, which provides a Raman readout that is then digitized to a cryptographic key. e, Schematic of the fabrication of a visual PUF tag made from a suspension of silk MPs doped with FeCl₃, which is captured by a pocket microscope to provide an image readout as the input for PUF code generation.

FIG. 2. PUF code extraction from the silk MPs-based spectral tags. a, Photographs of silk MPs-based spectral tags deposited on tulip bulbs, corn, zucchini, apple and eggplant seeds. Scale bars, 5 mm. b, An adhesive mask with a cross-shaped window was applied to the silk tag deposited on a bush bean seed, to ensure Raman mapping of a fixed area within the silk tag across different measurements. Scale bar, 5 mm. SEM characterization of the silk tag, showing stochastic distribution of silk MPs in the tag. A central area of 90×90 μm² of the silk tag was selected for Raman mapping and a mapping resolution of 4×4 was used throughout this study, generating 16 Raman spectra (numbered from 0 to 15) arranged in 4 rows and 4 columns. Scale bars, 200 μm (bottom left) and 10 μm (right). c, Comparison of two Raman spectra (#1 and #12) using peak intensities at several Raman shifts—(#0) 905 and 960 cm⁻¹ (α-helical peaks), (#1) 975 and 1005 cm⁻ (breathing modes of benzene rings), (#2) 1230 and 1265 cm⁻¹ (Amide III peaks), and (#3) 1665 cm⁻ (Amide I peak). d, Illustration of the challenge-response protocol for spectral PUFs: (i) The challenge comprises 1280 bits, which is organized in 128 blocks with each block being a 10-bit binary code. The response comprises 128 bits, where each response bit is obtained by comparing two Raman spectra using one of the four parameters given in (c), as indicated by the corresponding challenge block. (ii) An example PUF code of 128-bit computed from a randomly generated challenge of 1280-bit.

FIG. 3. PUF code extraction from the silk MPs-based visual tags. a, Processing of the silk-iron tag image to be used for PUF computation: (i) Photograph of a silk-iron tag deposited on a bush bean seed. Scale bar, 5 mm. (ii) Raw image of the silk-iron tag in (i) captured by a pocket microscope. (iii) Resized tag image of 400×400 pixels generated from the raw image in (ii). (iv) Luminance-compensated tag image containing only the intrinsic color information. (v) Contrast-enhanced tag image by applying histogram equalization to the image in (iv). (vi) Grayscale image converted from the RGB image in (v). (vii) Core region of the grayscale tag image partitioned into 8×8=64 areas. (viii) An 8×8 array showing the averaged intensities (i.e. shades of gray) of each area in (vii). b, Illustration of the challenge-response protocol for visual PUFs: (i) The challenge comprises 1536 bits, which is organized in 128 blocks with each block being a 12-bit binary code. The response comprises 128 bits, where each response bit is obtained from its corresponding challenge block. (ii) Computation of PUF responses by comparing the intensities of two areas whose indexes are indicated by the given challenges. (iii) An example PUF code of 128-bit computed from a randomly generated challenge of 1536-bit.

FIG. 4. Evaluation of bit uniformity, uniqueness and repeatability of the silk MPs-based PUFs. a,b, PUF codes that are repeatedly generated from (a) 30 spectral tags and (b) 30 visual tags under the same challenge. For each tag in (a) and (b), its PUF codes are displayed in two rows with the top and bottom row representing the PUF code obtained from the 1st (original) and 2nd (repeated) measurement. c,d, Histograms of the bit uniformity of (c) 30 spectra PUFs and (d) 30 visual PUFs. e,f, Histograms of intra-tag HDs and inter-tag HDs for (e) 30 spectra PUFs and (f) 30 visual tags, along with their Gaussian fitting results. g,h, Pairwise comparisons among the PUF codes obtained from (g) 30 spectral tags and (h) 30 visual tags. Good PUF uniqueness is indicated by the non-diagonal elements in (g) and (h) having colors that correspond to inter-tag HDs of ˜0.5. i,j, Pairwise comparisons among the PUF codes obtained from (i) 30 spectral tags and (j) 30 visual tags across two measurements. Good PUF repeatability is indicated by the diagonal elements in (i) and (j) having colors that correspond to intra-tag HDs of ˜0.

FIG. 5. Size distribution of the four types of silk microparticles as measured by DLS.

FIG. 6. Characterization of the three peptides used in templated crystallization of silk. a, Negative-stain TEM images of (GCGAGA)₂, (SEQ ID NO:20) GAGAGSGAAS (SEQ ID NO:21) and HB SP (refers to honeybee silk peptide) supramolecular nanoassemblies formed in water. b, 1-D WAXS spectra of (GCGAGA)₂ (SEQ ID NO:20), GAGAGSGAAS (SEQ ID NO:21) and HB SP nanoassemblies, showing distinct intra-/intermolecular distances. c, Raman spectra of (GCGAGA)₂ (SEQ ID NO:20), GAGAGSGAAS (SEQ ID NO:21) and HBSP (SEQ ID NO:23), showing distinct spectral fingerprints of the three peptides.

FIG. 7. Display of 300 PUF codes obtained from (a) 30 spectral tags and (b) 30 visual tags, by applying 10 randomly generated challenges to each tag. These PUF codes were submitted to the NIST statistical test suite for evaluation of randomness.

FIG. 8. Images of a visual PUF tag captured by the pocket microscope before and after storing the tag at room temperature (23° C.) and 75% relative humidity (RH) for 7 days.

FIG. 9. Images of a visual PUF tag captured by the pocket microscope before and after storing the tag at 50° C. and 75% RH for 7 days.

FIG. 10. Protocol of PUF challenge generation for (a) spectral tags and (b) visual tags. a, For spectral tags, by applying the fixed AES cipher key of 128-bit (1^{st} row) to a challenge seed of 128-bit (2^{nd} row) for 10 iterations, an expanded challenge of 1280-bit (3r d row) is obtained which is organized in 128 columns (i.e. blocks) with each block comprising 10 bits. The expanded challenge is then examined to identify problematic challenge blocks (marked by arrows) that indicate meaningless comparisons between the same area within a silk tag. The 8^{th} bit of each problematic challenge block is then flipped while the bits of other challenge blocks remain unaltered, generating the final PUF challenge (4^{th} row). b, For visual tags, PUF challenge generation follows a similar process, except that the fixed AES cipher key (1^{st} row) is applied to a challenge seed (2^{nd} row) for 12 iterations, generating an expanded challenge of 1536 bit (3^{rd} row) which is organized in 128 columns (i.e. blocks) with each block comprising 12 bits, and the 12^{th} bit of each problematic challenge block is flipped to generate the final PUF challenge (4^{th} row).

### DETAILED DESCRIPTION

As used herein, the amino acid residues are abbreviated as follows: alanine (Ala; A), asparagine (Asn; N), aspartic acid (Asp; D), arginine (Arg; R), cysteine (Cys; C), glutamic acid (Glu; E), glutamine (Gln; Q), glycine (Gly; G), histidine (His; H), isoleucine (Ile; I), leucine (Leu; L), lysine (Lys; K), methionine (Met; M), phenylalanine (Phe; F), proline (Pro; P), serine (Ser; S), threonine (Thr; T), tryptophan (Trp; W), tyrosine (Tyr; Y), and valine (Val; V).

In all embodiments of polypeptides disclosed herein, any N-terminal methionine residues are optional (i.e.: the N-terminal methionine residue may be present or may be absent).

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural or singular number, respectively. Additionally, the words “herein,” “above” and “below” and words of similar import, when used in this application, shall refer to this application as a whole and not to any particular portions of this application.

All embodiments of any aspect of the invention can be used in combination, unless the context clearly dictates otherwise.

As used herein, “about” means +/−5% of the recited value.

In a first aspect, the disclosure provides compositions comprising a first product, wherein the first product comprises a physical unclonable function (PUF) tag comprising silk particles conformably and directly attached to the first product, wherein the PUF tag cannot be reattached to a second product once removed from the first product.

The recited PUF tags made of silk microparticles can be seamlessly attached to any product. The PUF tag for given first product provides, for example, a unique Raman Spectroscopy (RS) spectra (when using RS for authentication), which serves as a unique identifier for that given first product that can be distinguished from other first products having a different PUF tag comprised of silk microparticles that possess a different RS spectra.

The phrase “conformably attached” as used herein means an attachment that adapts to the surface curvature and shape of the agricultural product.

The phrase “directly attached” as used herein means bonding of the PUF tag to the first product. In one embodiment, the PUF tag may be non-covalently bound to the first product. By way of example only, the attached examples demonstrate such non-covalent bonding of the PUF tag to a first product (exemplified by a seed) by drop casting a solution of silk particles on the first product, such that the PUF tag is directly formed on each first product after water evaporation, so that the tag become an integral part of the product, rather than a pre-made tag that is later attached to the product. Such non-covalent bonds cannot be reversibly formed when a PUF tag is removed from a first product and attempted to be attached to another product. In some embodiments, removing the PUF tag from its binding surface on the first product breaks the integrity of the silk tag, and attempting to reattach the PUF tag to the same or a different first product does not generate the same amount of bonding.

The PUF tag cannot be reattached to a second product once removed from the first product, thus improving anti-counterfeiting efforts using the disclosed PUF tags.

In some embodiments, the PUF tag does not maintain its intactness and/or its adhesiveness when removed from the first product. The phrase “does not maintain its intactness when removed from the first product” means that the PUF tag structure is lost when removed from the first product. The phrase “does not maintain its adhesiveness when removed from the first product” means that the PUF tag as removed from the first product will not adhere to a second product.

The first product may be any suitable first product to which the recited PUF tags of the disclosure may be attached. Exemplary first products include, but are not limited to agricultural products (which may include, but are not limited to seeds, tubers, bulbs, grains, seed coatings, sprayable chemicals, etc.); solid products for oral ingestion including (which may include, but are not limited to pharmaceuticals, diagnostic products, foods (including but not limited to nuts, fruits, vegetables, meat, fish, dairy products), injectable products (including but not limited to and injectable hydrogel that come in a dry format and may be reconstituted by adding solvent), and packaged products, wherein the PUF tag is conformably and directly attached to the package (which may include, but are not limited to packaged agricultural products, packaged products for oral ingestion, packaged beverages, packaged consumer goods, etc.)

As used herein, packaged beverages may be any beverage, including but not limited to bottled or canned beverages (including but not limited to wines and liquors), where the PUF tag may be on the cap, lid, or other packaging.

When the first product comprises a packaged product, the PUF tag is conformably and directly attached to the package, such that breaking the packaging breaks the PUF tag, such that the PUF tag serves as a tamper sensitive detector.

In one embodiment, the first product is a seed. The term “seed” as used herein refers to both horticultural and agricultural seed. Agricultural seeds include the seed of grass, legume, forage, cereal and fiber crops. Agricultural seeds include for instance seeds from grasses or cereal crops, including corn, wheat, barley, sorghum etc.; or seeds from vegetable crops such as carrot, onion, and tomato. Horticultural seeds include such seeds of crops, especially flowers, fruit, and vegetables generally grown in gardens or greenhouses. Such crops include tulip bulbs, zucchini, apple, eggplant, bush beans etc.

In one embodiment, the silk particles comprise silk fibroin having an average molecular weight of between about 5 kD and about 400 kD. As used herein, the term “silk fibroin” refers to silk fibroin protein or fragment thereof, whether produced by silkworm, spider, or other insect, or otherwise generated (Lucas et al., Adv. Protein Chem., 13: 107-242 (1958)). Silk is naturally produced by various species, including, without limitation: Antheraea mylitta; Antheraea pernyi; Antheraea yamamai; Galleria mellonella; Bombyx mori; Bombyx mardarina; Galleria mellonella; Nephila clavipes; Nephila senegalensis; Gasteracantha mammosa; Argiope aurantia; Araneus diadematus; Latrodectus geometricus; Araneus bicentenarius; Tetragnatha versicolor; Araneus ventricosus; Dolomedes tenebrosus; Euagrus chisoseus; Plectreurys tristis; Argiope trifasciata; and Nephila madagascariensis. (See U.S. Pat. No. 11,147,282) In some embodiments, silk fibroin is obtained from a solution containing a dissolved silkworm silk or spider silk. For example, in some embodiments, silkworm silk fibroins are obtained, from the cocoon of Bombyx mori. In some embodiments, spider silk fibroins are obtained, for example, from Nephila clavipes. In the alternative, in some embodiments, silk fibroins suitable for use in the invention are obtained from a solution containing a genetically engineered silk or recombinantly produced silk harvested from bacteria, yeast, mammalian cells, transgenic animals or transgenic plants. See, e.g., WO 97/08315 and U.S. Pat. No. 5,245,012, each of which is incorporated herein by reference in its entirety.

Silk fibroin is a hydrophobic structural protein having amphiphilic properties. Silk fibroin heavy chain are made of amorphous and crystalline fractions. Beta-sheets of fibroin proteins stack to form crystals, whereas other segments form amorphous domains. See U.S. Pat. No. 11,147,282, incorporated by reference herein in its entirety. The protein secondary as well as tertiary structures can be further controlled due to the polymorphism of the protein, permitting control over the protein physical and mechanical properties. The molecular weight of regenerated silk fibroin varies depending on the processing conditions, such as boiling time.

Although different species of silk-producing organisms, and different types of silk, have different amino acid compositions, various fibroin proteins share certain structural features. A general trend in silk fibroin structure is a sequence of amino acids that is characterized by usually alternating glycine and alanine, or alanine alone. Such configuration allows fibroin molecules to self-assemble into a beta-sheet conformation. These “Ala-rich” and “Gly-rich” hydrophobic blocks are typically separated by segments of amino acids with bulky side-groups (e.g., hydrophilic spacers). See U.S. Pat. No. 11,147,282.

In some embodiments, core repeat sequences of the hydrophobic blocks of the silk fibroin are represented by the following amino acid sequences and/or formulae: (GAGAGS)₅₋₁₅(SEQ ID NO:1); (GX)₅₋₁₅ (X=V, I, A) (SEQ ID NO:2); GAAS (SEQ ID NO: 3); GX₁₋₄ GGX (SEQ ID NO: 4); GGGX (X=A, S, Y, R, D, V, W, R, D) (SEQ ID NO: 5); GLGGLG (SEQ ID NO: 6); GXGGXG (X=L, I, V, P) (SEQ ID NO:7); GPX (X=L, Y, I); (GP(GGX)₁₋₄ Y)n (X=Y, V, S, A) (SEQ ID NO:8); (GRGGA)₁₋₁₀ (SEQ ID NO:9); (GGX)₁₋₁₀(X=A, T, V, S) (SEQ ID NO:10); GAG(A)₆₋₇GGA (SEQ ID NO:11); and GGXGXGXX (X=Q, Y, L, A, S, R) (SEQ ID NO:12).

In some embodiments, the silk fibroin contains multiple hydrophobic blocks, e.g., 3, 4, 5, 6, 7, 8, 9, 10, 11, 12, 13, 14, 15, 16, 17, 18, 19 and 20 hydrophobic blocks within the peptide. In some embodiments, a fibroin peptide contains between 4-17 hydrophobic blocks. In some embodiments, the silk fibroin comprises at least one hydrophilic spacer sequence (“hydrophilic block”) that is about 4-50 amino acids in length. Non-limiting examples of the hydrophilic spacer sequences include peptides at least 75%, 80%, 85%, 90%, 91%, 92%, 93%, 94%, 95%, 96%, 97%, 98%, 99%, or 100% identical to TGSSGFGPYVNGGYSG (SEQ ID NO:13); YEYAWSSE (SEQ ID NO:14); SDFGTGS (SEQ ID NO:15); RRAGYDR (SEQ ID NO:16); EVIVIDDR (SEQ ID NO:17); TTIIEDLDITIDGADGPI (SEQ ID NO:18); and TISEELTI (SEQ ID NO:19).

Silk fibroin proteins are characterized by modular units linked together to form high molecular weight, highly repetitive proteins. These modular units or domains, each with specific amino acid sequences and chemistries, are thought to provide specific functions. For example, sequence motifs such as poly-alanine (polyA) and poly-alanine-glycine (poly-AG) are inclined to be beta-sheet-forming; GXX motifs contribute to 31-helix formation; GXG motifs provide stiffness; and, GPG contributes to beta-spiral formation (reviewed in Omenetto and Kaplan (2010) Science 329: 528-531; see also WO 2011/130335 (PCT/US2011/032195), the contents of which are incorporated herein by reference.

In various embodiments, the silk particles comprise silk fibroin having an average molecular weight of between about 5 kD and about 400 kD; about 5 kD and about 350 kD; about 5 kD and about 300 kD; about 5 kD and about 250 kD; about 5 kD and about 200 kD; about 5 kD and about 150 kD; about 5 kD and about 100 kD; about 50 kD and about 400 kD; about 50 kD and about 350 kD; about 50 kD and about 300 kD; about 50 kD and about 250 kD; about 50 kD and about 200 kD; about 50 kD and about 150 kD; about 50 kD and about 100 kD; about 100 kD and about 400 kD; about 100 kD and about 350 kD; about 100 kD and about 300 kD; about 100 kD and about 250 kD; about 100 kD and about 200 kD; or about 100 kD and about 150 kD.

In one embodiment, the silk particles comprise or consist of crystalline silk. As discussed in the attached appendices, crystalline silk (i.e. silk molecules folded in highly ordered structures including but not limited to β-sheets, β-turns and α-helix) are not susceptible to humidity and temperature, and thus provide increased stability against environmental factors that might occur during products storage and transportation over a long period of time.

In another embodiment, the PUF is biodegradable, and/or is edible. Silk can be degraded by certain enzymes (e.g. protease XIV and α-chymotrypsin), soil microbes and in marine environment, and the degradation rates vary from days to years depending on the crystallinity of silk. In one embodiment, the silk particles comprise microparticles and/or nanoparticles. “Microparticles” as used herein means particles having sizes between 0.1 and 100 μm along their largest dimensions. “Nanoparticles” as used herein means particles having sizes between 1 and 100 nm along their largest dimensions.

In another embodiment, the composition comprises a plurality of the first products. In various embodiments, the plurality of first products comprises 2, 5, 10, 25, 50, 100, 250, 500, 1000, 2500, 5000, 10,000, or more first products. By way of non-limiting example, a plurality of agricultural first products such as seeds may include hundreds or more first products, while a plurality of packaged first products such as beverages or consumer goods may include several or tens of first products. In one embodiment, the composition further comprises additional first products that do not comprise a PUF tag. It will be understood based on the teachings herein that the composition comprises enough first products comprising the PUF tag to permit authentication, and may comprise some or many non-PUF tagged first products.

By way of non-limiting embodiment, and as discussed in the attached appendices, a proportion of seeds (for example) being labeled with PUF tags may vary depending on seed type, seed value and the amount of seeds sold in a batch etc. For high-end products like a special breed of tulip bulbs, one may choose to label each bulb with a unique PUF tag; while for seeds sold in large volumes such as rice seeds, labeling a small portion of seeds randomly picked from a whole batch (e.g. at least 1%, 2%, 3%, 4%, 5%, etc.) should be sufficient for authentication of the entire bag of seeds.

In another embodiment, the plurality of first products comprise a plurality of molecularly distinct PUF tags comprising different silk polymorphs. As used herein “polymorphism” refers to the ability of the silk proteins to assume different secondary, tertiary and quaternary structures achieved by controlling the protein folding and assembly pathways during particle production. As such, silk polymorphs may have identical amino acid sequences, or different amino acid sequences (as described above), but adopt different structures/conformations, depending on how the silk molecules are directed to fold and assemble during particle production. In one embodiment, the different silk polymorphs may have the same amino acid sequence. In other embodiments, the different silk polymorphs may have differences in amino acid sequence.

In this embodiment, the different first products are distinguishable because each PUF on an individual first product has a molecularly distinct PUF tag. By way of non-limiting example, the inventors have shown that by drop casting a mixture of variant silk microparticles on a first product (exemplified by a seed), tamper-evident PUF tags can be seamlessly attached to the first product, with the unclonability based on the stochastic assembly of spectrally and/or visually distinct silk microparticles in each PUF tag.

As further shown herein, unique, reproducible and unpredictable PUF codes are generated from both Raman mapping and optical imaging of the PUF tags. In one embodiment, the plurality of PUF tags in the composition have distinct Raman spectroscopy spectra, permitting generating of PUF codes for the composition by Raman mapping of the PUF tags in the composition. In another embodiment, the plurality of molecularly distinct PUF tags comprise colored salts (including but not limited to FeCl₃ CuCl₂, CuSO₄, MnCl₂, FeSO₄, etc., and combinations thereof) having random and visually distinct patterns in the plurality of PUF tags, permitting generating of PUF codes for the composition by optical imaging (including but not limited to microscopy or use of a macro lens) of the PUF tags in the composition.

In another embodiment, the silk particles comprise a marked region to standardize Raman mapping and/or optical imaging of the composition. In one non-limiting embodiment, a mask of any defined shape or size can be applied to the PUF tags, with Raman reading or optical imaging focused on the masked area.

In another aspect, the disclosure provides methods for preparing the composition of any preceding claim, comprising:

(a) templated crystallization of silk fibroin into different polymorphs by mixing (i) a first solution of silk fibroin with (ii) a solution of peptides that possess the following properties: (i) capable of forming ordered supramolecular nanoassemblies; (iii) capable of binding to silk molecules through non-covalent interactions; and (iv) sharing a similar isoelectric point and pH stability to that of silk fibroin, to form a mixture;

(b) incubating the mixture to form silk-peptide microparticles in the mixture;

(c) freeze-drying the mixture comprising silk-peptide microparticles to obtain lyophilized silk powders;

(d) grinding the silk powders to obtain silk microparticles;

(e) drop casting a suspension composed of the silk microparticles and amorphous silk molecules on the first products to form PUF tags conformably and directly attached to the first products.

The suspension composed of the silk microparticles and amorphous silk molecules comprises spectrally distant, polymorphic silk MPs due to the different secondary, tertiary and quaternary structures achieved by controlling the protein folding and assembly pathways during particle production. As described in detail in the examples, the inventors have shown that the methods of the disclosure provide for seamlessly attaching tamper-evident PUF tags to a variety of products, where the unclonability comes from the stochastic assembly of spectrally and visually distinct silk polymorph microparticles in the tag. Unique, reproducible and unpredictable PUF codes can then be generated from both Raman mapping and optical imaging (including but not limited to microscopy or use of a macro lens) of the PUF tags.

In one embodiment, the amorphous silk molecules comprise silk microparticles, such as silk comprising β-turns, helices and β-pleated sheets. In one embodiment, the amorphous silk microparticles are produced by spray drying or spray freeze drying to generate silk MPs of sizes 2-20 μm. Exemplary such techniques for producing amorphous silk molecules and microparticles are disclosed in the appendices.

In another embodiment, the peptides used in step (a) may include, but are not limited to, one or more of (GCGAGA)₂ (SEQ ID NO:20); (2) GAGAGSGAAS (SEQ ID NO:21); and (3) a coiled-coil peptide of sequence ALKAQSEEEAASARANAATAATQSALEG (SEQ ID NO:22) derived from the silk fibroin AmelF3 of European honeybee Apis mellifera (referred to as honeybee silk peptide (HBSP).

In a further embodiment, step (b) (incubating the mixture to form silk-peptide microparticles in the mixture) comprises an initial formation of silk-peptide nanocomplexes and their subsequent growth to micrometer sizes as characterized by a gradual increase in solution turbidity.

In one embodiment, step (c) (freeze-drying the mixture comprising silk-peptide microparticles to obtain lyophilized silk powders) comprises freeze-drying after templated crystallization reaches equilibrium.

In another embodiment, step (e) comprises drop casting a suspension composed of spectrally distinct silk MPs and amorphous silk molecules at a mass ratio in the range of 2:1 to 3:1 in the final suspension, followed by air drying. In another embodiment, step (f) comprises drop casting a suspension composed of spectrally distant silk MPs at about 0.7 wt % and amorphous silk molecules at about 0.3 wt % on the first product, followed by air drying.

The first product may be any first product as disclosed for the compositions of the disclosure.

In another aspect, the disclosure provides methods for analyzing the composition of any preceding claim, comprising Raman mapping of a selected area in the PUF tag, generating a matrix of Raman spectra (i.e.: a spectral PUF). In one embodiment, the matrix of Raman spectra can be digitized to a binary cryptographic key (i.e.: PUF code). As described in detail in the examples, the inventors have shown that unique, reproducible and unpredictable PUF codes can then be generated from both Raman mapping of the PUF tags, based on spectrally distant, polymorphic silk MPs on the first products due to the different secondary, tertiary and quaternary structures achieved by controlling the protein folding and assembly pathways during particle production.

In one embodiment, the selected area comprises the same are on all PUF tags on first products in the composition, to enhance reproducibility. In one embodiment, the PUF tags comprise a marked region to facilitate standardizing Raman mapping.

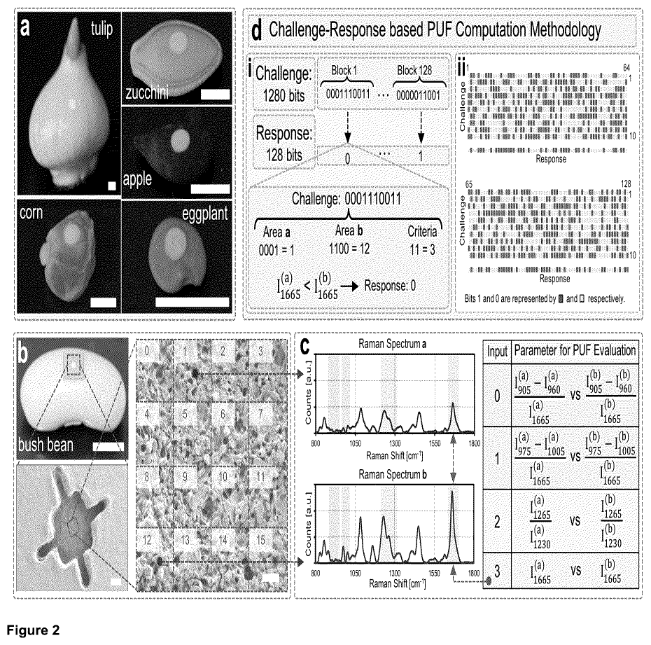

In one embodiment, Raman mapping comprises a mapping resolution of at least 4×4 to generate 16 Raman spectra. In a further embodiment, a PUF code may be generated from the Rama Spectra by electing two spectra a and b and then comparing them using one of the following four parameters:

$$( \#0 ) \frac{{I}_{905} - {I}_{960}}{{I}_{1665}} , ( \#1 ) \frac{{I}_{975} - {I}_{1005}}{{I}_{1665}} , ( \#2 ) \frac{{I}_{1265}}{{I}_{1230}} and ( \#3 ) {I}_{1665} ,$$

where I represents Raman peak intensity, and the subscript corresponds to Raman peak position in cm⁻¹. In one such embodiment, if the chosen parameter of spectrum a is larger than that of spectrum b, the response generated is 1; otherwise, it is 0. Any suitable technique may be used to determine which of the Raman spectra are to be compared. In one non-limiting embodiment, a 1280-bit challenge may be used, as detailed in the examples. For example, the 1280-bit challenge may be composed of 128 blocks with each block being a 10-bit binary code. Taking one challenge block—0001110011 for example (FIG. 2d(i)), the first two groups of 4 digits (i.e. 0001 and 1100) indicate the indexes of the two Raman spectra to be compared (i.e. 1 and 12 in decimal numbers), and the last 2 digits (i.e. 11) indicate the index of the parameter used to compare the two Raman spectra (i.e. parameter #3). In this case, because I₁₆₆₅^{(a)}<I₁₆₆₅^{(b)}, the response generated for this challenge block is 0. Since each challenge block generates a response of 1-bit, a 1280-bit challenge of 128 blocks then generates a response of 128-bit as the final PUF code for a spectral tag (FIG. 2d(ii)). Based on this challenge-response protocol, the PUF code generated depends not only on the physical properties of the silk tags (i.e. the distribution of spectrally distinct silk MPs within the tag), but also on the challenge applied to the Raman readout.

In another embodiment, the disclosure provides methods for analyzing the composition of any preceding claim wherein the PUF tags comprise colored inorganics exhibiting random and visually distinct patterns, comprising detecting the random and distinct visual patterns (i.e.: a visual PUF). In one embodiment, the colored inorganic comprises a colored salt, including but not limited to FeCl₃, CuCl₂, CuSO₄, MnCl₂, FeSO₄, etc., and combinations thereof). In other embodiments, the colored inorganics may comprise pigments, particles of photonic crystals, and/or colored microparticles.

In one embodiment, the detecting may comprise generating using a pocket microscope connected with a smart phone and processed by digitizing to a binary cryptographic key (i.e.: a PUF code). In a further embodiment, the methods comprise standardizing all images and compensating for image-to-image variations in magnification, brightness and/or contrast, prior to generating the PUF code. In one exemplary embodiment, the detecting initially comprises isolating only the silk-inorganic tag by using an edge detection technique and converting to a fixed-sized image, and extracting only the intrinsic color information of the tag image by using a luminance reduction technique. The method may further comprise applying a histogram equalization-based contrast enhancement technique to increase the separation between lighter and darker regions, and may further comprise obtaining a contrast-enhanced RGB image. In one embodiment, the RGB image may be converted to a grayscale image, followed by selecting a region of the grayscale image (such as a central region) and partitioning it into a plurality of different areas. The method may further comprise calculating mean intensities (i.e. shades of gray) of each area, with the intensity array as the input to the visual PUF challenge-response protocol, as described above. In a further embodiment, generating the PUF tag may comprise comparing the intensities of two areas a and b (denoted as Iₐ and I_{b}) selected from the array. If Iₐ>I_{b}, the PUF response generated is 1; otherwise, it is 0. The indexes of the two areas to be compared may be determined by the two components of 6 bits in each challenge block. In a non-limiting embodiment (described in more detail in the examples), taking a 1^{st} challenge block—000111001101 for example, the first 6 bits (i.e. 000111) indicates the index of area a (which is 7 in decimal number) and the successive 6 bits (i.e. 001101) indicates the index of area b (which is 13 in decimal number). Since Iₐ=I₇>I_{b}=I₁₃, the 1^{st} PUF response for the 1^{st} challenge block is 1. Similarly, to generate the 128^{th} PUF response for the 128^{th} challenge block—000001100100, I₁ and I₃₆ were compared. Since I₁>I₃₆, the 128^{th} PUF response is also 1.

### EXAMPLES

Smallholder farmers and manufacturers in the Agri-Food sector face significant challenges as a result of the increasing circulation of counterfeit products (e.g. seeds), which poses a tremendous threat to farmer livelihoods and significantly impairs the overall capacity of sustainable food production. Current efforts to combat counterfeit agricultural goods are implemented mainly at the secondary packaging level, and are generally vulnerable due to limited security guarantees. Here, by integrating biopolymer design with physical unclonable functions (PUFs), we propose a cryptographic protocol for seed authentication using biodegradable and miniaturized PUF tags made of silk microparticles. By drop casting a mixture of variant silk microparticles on a seed surface, tamper-evident PUF tags can be seamlessly attached to a variety of seeds, where the unclonability comes from the stochastic assembly of spectrally and visually distinct silk microparticles in the tag. Unique, reproducible and unpredictable PUF codes are generated from both Raman mapping and microscopy imaging of the silk tags. Together, we demonstrate the capability to establish unclonable authentication features at the individual seed level, which serves as a highly secure solution for anticounterfeiting and product traceability in agriculture.

Counterfeiting has been a global, long-lasting, and unsolved issue that permeates virtually every field of our society from the luxury goods industry to pharmaceuticals. Physical unclonable function (PUF) refers to a physical object that uses its intrinsically random variations to provide a unique and unpredictable output (response) under an external stimulus (challenge). The responses of PUFs rely on their underlying physical characteristics which possess stochastic and uncontrollable features introduced during manufacturing. The fact that exact control over the manufacturing process is infeasible makes it extremely difficult if not impossible to duplicate a PUF device.

Little attention has been given to counterfeiting and product traceability issues in agriculture. Taking the seed business for example, there has been a continuing increase in illegal seed practices, including counterfeit seeds, fraudulent labeling, trademark infringements, intellectual property infringements, regulatory offences and thefts of proprietary material (24). This is not surprising as the global commercial seed market was valued at USD 62.90 billion in 2020, and is projected to reach USD 100.36 billion by 2026 (25). In some countries, during the growing seasons, more than 50% of crop seeds sold to farmers are illegal or counterfeit (26). Moreover, trade of illegal seeds continues to increase at a rate of circa 5% per year in eastern and southern Africa (27). As seeds are the most important input in crop production, such illegal seed practices pose a tremendous threat to farmers' livelihoods and significantly impair the overall capacity of sustainable food production to feed the fast-growing population, which is projected to reach 9.7 billion by 2050 (28). To the best of our knowledge, however, PUF-based solutions have not been explored in the Agri-Food domain. Moreover, as agricultural products like seeds are sold in large volumes and at low profit margins, their anticounterfeiting measures require facile and low-cost implementation at scale, thus limiting the use of costly raw materials and sophisticated micro-/nanofabrication techniques. Besides, given that the anticounterfeiting devices applied to agricultural products will inevitably end up in the environment or might be ingested during food consumption, the materials used to make those devices should ideally be biodegradable, non-toxic and even edible.

Here, we propose a cryptographic protocol for seed authentication using biodegradable and miniaturized PUF tags made of silk microparticles (MPs) that can be directly applied on the surface of a variety of seeds. With templated crystallization and spray drying followed by water annealing, silk microparticles of four different polymorphs were obtained which possess distinct molecular fingerprints that can be revealed by Raman spectroscopy. Drop casting a suspension made of variant silk MPs and amorphous silk on the seed surface followed by water evaporation induced MPs assembly leads to formation of a PUF tag firmly attached to the seed, where the intrinsic entropy comes from the random distribution of molecularly distinct silk MPs in the tag, thereby making the tag unclonable due to the stochastic assembly process introduced during tag fabrication. PUF codes were generated from Raman mapping of the silk MPs tags followed by digital processing of the Raman readouts under a given challenge. A further modification of the silk MPs-based PUF was achieved by addition of colored salts (e.g. FeCl₃) in the silk MPs suspension to allow for silk-inorganics co-assembly during water evaporation, resulting in formation of random and distinct visual patterns that can be captured by a pocket microscope and processed through a similar digitization protocol. Uniqueness and readout reproducibility of our silk MPs-based PUF tags were validated by evaluating their Hamming Distances, and randomness of the PUF codes were verified by applying the National Institute of Standards and Technology (NIST) statistical test suite. Together, by leveraging biopolymer design with PUFs, we demonstrate the capability to establish unclonable authentication features at the individual seed level, with the requirement of a minimal amount of materials (less than 50 μg silk per seed) and the use of easily scalable manufacturing techniques. We believe that our technology serves as a highly secure solution for product traceability in the Agri-Food domain and it can be easily adapted to other commodities for anti-counterfeiting and beyond.

### Results

### Engineering Variant Silk MPs for Fabrication of Tamper-Evident Tags on Seeds.

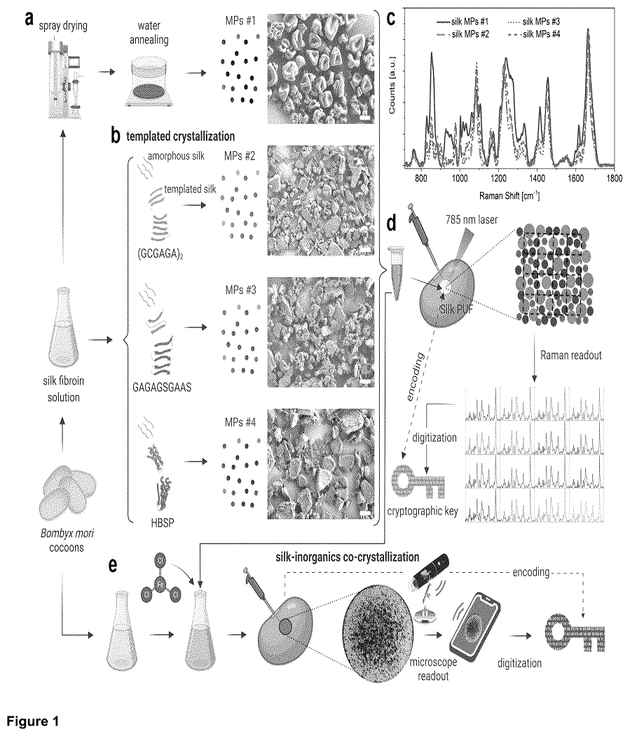

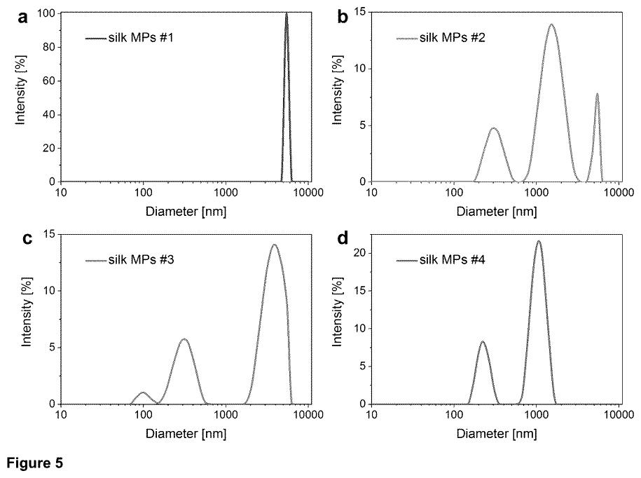

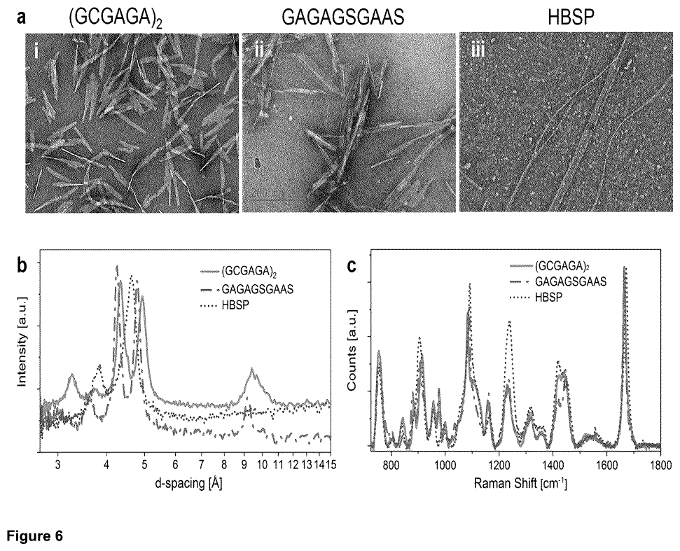

To obtain spectrally distinct silk MPs, we took advantage of the polymorphism of structural proteins, which refers to their ability to assume different secondary, tertiary and quaternary structures achieved by controlling the protein folding and assembly pathways. Here, bottom-up directed assembly and rapidly scalable top-down manufacturing were integrated to fabricate silk MPs of four different polymorphs. Firstly, spray drying was used to generate silk MPs of sizes 2-20 μm (FIG. 1a, FIG. 5a) (34), followed by water annealing of those particles to induce formation of silk I structure and render them water-insoluble. The choice of the spray drying technique was based on its high efficiency in producing grams of protein powders per hour and its wide use in industry. Exposing the spray-dried silk MPs to water vapor for a prolonged time (i.e. water annealing of the amorphous silk MPs) then allows the random coil fibroin chains to slowly self-assemble into a silk I form which is rich in type II β-turns and water-stable albeit lacking sufficient β-sheet contents. To obtain the other three silk polymorphs, we employed a recently developed technique named templated crystallization, where highly-ordered peptide nanoassemblies were used to guide the folding and assembly of amorphous silk molecules into ordered structures that resemble that of the peptide. This is achieved through fibroin chain re-configuration after binding to the peptide seeds which then template assembly of the folded fibroin chains into higher order structures. Based on our extensive experiences in silk protein design, we selected three peptides capable of templating silk into distinct polymorphs (FIG. 1b): (1) (GCGAGA)₂ (SEQ ID NO:20); (2) GAGAGSGAAS (SEQ ID NO:21); and (3) a coiled-coil peptide of sequence ALKAQSEEEAASARANAATAATQSALEG (SEQ ID NO:22) derived from the silk fibroin AmelF3 of European honeybee Apis mellifera (38). For simplicity, this peptide is noted as honeybee silk peptide (HBSP) thereafter. The first two peptides ((GCGAGA)₂ (SEQ ID NO:20) and GAGAGSGAAS (SEQ ID NO:21)) self-assemble into short nanowhiskers of sizes around 200×20×4 nm (FIG. 6a) and of highly ordered β-sheet structures, but the molecular arrangements and packing of individual peptide chains are different as characterized by Wide-angle X-ray Scattering (WAXS) and Raman spectroscopy (FIGS. 6b,c). HB SP also forms supramolecular nanoassemblies in water, which possess a less regularly defined morphology and a combination of β-sheet and α-helix secondary structures (FIG. 6). The templated crystallization process starts with mixing each of the three peptides with silk fibroin, after which a gradual increase in solution turbidity was observed, indicating the formation of silk-peptide nanocomplexes and their growth to micrometer sizes. After letting each solution age until the templated crystallization process reaches equilibrium, we freeze-dried the solution to obtain powders of crystallized silk. The lyophilized silk powders were then ground to finer sizes by using a mortar and a pestle, with the final silk particles showing a polygonal shape and ranging in size from 1 to 30 μm (FIG. 1b, FIGS. 5b-d).

Raman characterization show distinct spectral fingerprints of the four silk MPs obtained by water annealing and templated crystallization (FIG. 1c), due to differences in the underlying silk polymorphs. For examples, a band at around 880 cm⁻¹ (which relates to the presence of β-sheets adopted by poly-(alanylglycine) sequences (39)) is present in the Raman spectra of silk MPs #2-4, but absent in that of silk MPs #1, due to the lack of antiparallel β-pleated sheets in water-annealed silk (35); A band at around 1103 cm⁻¹ characteristic of type II β-turns (40) is present in the spectrum of silk MPs #1 but absent in those of silk MPs #2-4; The intensity ratio of the tyrosine Fermi doublet at 830 and 850 cm⁻ (which serves as a spectral marker of the environment of the phenoxyl groups and the strength of hydrogen bonds involving tyrosine residues) is different among the four silk MPs, which is associated with different folding patterns of the fibroin chains resulted from different templating agents (41); and the significant spectral differences in the Amide III region (1200-1350 cm⁻) of the four silk MPs, including a major band shift from around 1240 cm⁻¹ in silk MPs #1 to around 1228 cm⁻¹ in silk MPs #2-4, changes in band width at half height with sharper peaks corresponding to higher silk crystallinity (i.e. β-sheet contents), and appearance and absence of bands at 1210, 1260, 1265 and 1332 cm⁻¹ in silk MPs of different polymorphs, among others. These distinctive peak features serve as the basis for digitization of the Raman readout from our silk MPs-based PUF tags.

By simply drop casting a suspension containing all 4 silk MPs (at 0.7 wt %) and amorphous silk molecules (at 0.3 wt %) on a seed, a white tag composed of randomly distributed and spectrally distinct silk MPs can be seamlessly attached to the seed surface after water evaporation. Raman mapping of a selected area in that silk tag was then performed, generating a matrix of Raman spectra followed by its digitization to a binary PUF code (FIG. 1d). We refer to this silk tag as a spectral PUF hereafter. Another variation of the silk MPs-based PUF was achieved by addition of colored salts (50 mM FeCl₃) in the silk MPs suspension to allow for silk-inorganics co-crystallization during water evaporation, resulting in formation of random and distinct visual patterns that can be captured by an inexpensive pocket microscope connected with a smart phone and processed through a similar digitization protocol (FIG. 1e). The choice of FeCl₃ here was based on iron being one of the essential micronutrients for plants. Given that the typical range of iron concentration in cultivated soils is 20-40 g/kg, our silk tags containing 28 μg iron per tag add little disturbance to the Fe dynamics in soil ecosystems (43). We refer to this silk tag as a visual PUF hereafter.

With this drop casting method, we were able to conformably and seamlessly attach silk MPs-based tags on a variety of seeds, for example tulip bulbs, corn, zucchini, apple, eggplant and bush bean seeds (FIGS. 2a, b). This demonstrates the broad applicability of our silk tags on a diverse range of seeds that possess vastly different size, shape, color and surface texture. Besides, the resulting silk tags are resistant to normal damaging forces such as wiping with a table cloth and those generated during transportation (e.g. friction between seeds as well as between seeds and containers/packages). The tight and conformable bonding between our silk tag and the seed coat is attributed to the presence of amorphous silk molecules acting as an adhesive matrix to hold the silk MPs together and to form a seamless interface with the seed coat. Moreover, the silk MPs-based tag loses its integrity as soon as it is removed from the underlying seed, making it tamper-evident. This also ensures that each silk tag only works with the seed it was originally attached to and it cannot be reapplied on any other seeds.

PUF Code Extraction from the Silk MPs-Based Tags on Seeds.

For spectral PUFs, as Raman mapping of the same area within each silk tag is required for reproducible seed authentication at each stage of the supply chain, a mask with a cross-shaped window was applied to the silk tag (FIG. 2b). With the four arms of the cross, the center of the exposed silk area can be reproducibly located (denoted as (0, 0) for simplicity), thereby ensuring Raman data collection on the same area of the silk tag. Typically, a 90×90 μm² area centered at (0, 0) was selected for Raman mapping and a mapping resolution of 4×4 was used throughout this study. This generates 16 Raman spectra (numbered from 0 to 15) arranged in 4 rows and 4 columns (FIG. 2b). A PUF code can be generated from these 16 Raman spectra by selecting two spectra a and b and then comparing them using one of the following four parameters

$$( \#0 ) \frac{{I}_{905} - {I}_{960}}{{I}_{1665}} , ( \#1 ) \frac{{I}_{975} - {I}_{1005}}{{I}_{1665}} , ( \#2 ) \frac{{I}_{1265}}{{I}_{1230}} and ( \#3 ) {I}_{1665} ,$$

where I represents Raman peak intensity, and the subscript corresponds to Raman peak position in cm⁻¹ (FIG. 2c). Selection of these four parameters was based on identification of the most significant variations in Raman peak features across different areas of the silk MPs tag. More detailed explanation on their associated vibrational modes of molecules can be found in Supporting Information. During each comparison, if the chosen parameter of spectrum a is larger than that of spectrum b, the response generated is 1; otherwise, it is 0. As for which two of the 16 Raman spectra are to be compared and which parameter is used for comparing the two spectra, this is determined by a 1280-bit challenge (FIG. 2d(i)). The 1280-bit challenge is composed of 128 blocks with each block being a 10-bit binary code. Taking one challenge block—0001110011 for example (FIG. 2d(i)), the first two groups of 4 digits (i.e. 0001 and 1100) indicate the indexes of the two Raman spectra to be compared (i.e. 1 and 12 in decimal numbers), and the last 2 digits (i.e. 11) indicate the index of the parameter used to compare the two Raman spectra (i.e. parameter #3). In this case, because I₁₆₆₅^{(a)}<I₁₆₆₅^{(b)}, the response generated for this challenge block is 0. Since each challenge block generates a response of 1-bit, a 1280-bit challenge of 128 blocks then generates a response of 128-bit as the final PUF code for a spectral tag (FIG. 2d(ii)). Based on this challenge-response protocol, the PUF code generated depends not only on the physical properties of the silk tags (i.e. the distribution of spectrally distinct silk MPs within the tag), but also on the challenge applied to the Raman readout. It is noted that although there are a total of (16×15/2)×4=480 pairs of unique comparison that can be made for 16 spectra and 4 parameters, one does not have to go through every comparison for the Raman readout of each tag. The number of challenge blocks mainly depends on the desired length of PUF response (that is, the encoding capability of PUFs) and can be chosen to be any integer in the range of 1 to 480 based on customer needs. Considering that an encoding capability of 2¹²⁸ is sufficient for most authentication applications and for the purpose of idea demonstration, here we chose the PUF challenge to be composed of 128 blocks generating a PUF response of 128 bits.

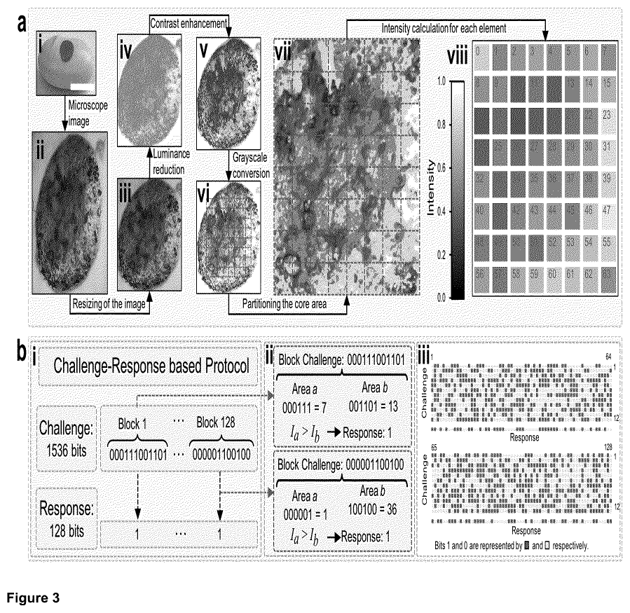

For visual PUFs (FIG. 3a(i)), the PUF codes were extracted from the magnified images of silk-iron tags captured using a pocket microscope (FIG. 3a(ii)). Before using them for PUF computation, several image processing steps were applied to the raw microscope images (45), in order to standardize all images and compensate for image-to-image variations in orientation, magnification, brightness and contrast. Therefore, no pre-alignment of the silk-iron tags to the microscope is required. Firstly, only the silk-iron tag was isolated by using a standard edge detection technique and converted to a fixed-sized image of 400×400 pixels (FIG. 3a(iii)). Since the tag image is influenced by the lighting conditions (luminance) which may vary from measurement to measurement, we extracted only the intrinsic color information of the tag image by using a luminance reduction technique (FIG. 3a(iv)). We then applied a histogram equalization-based contrast enhancement technique to increase the separation between lighter and darker regions, and obtained a contrast-enhanced RGB image of 400×400 pixels (FIG. 3a (v)). This RGB image was then converted to a grayscale image (FIG. 3a(vi)), followed by selecting its central region of 280×280 pixels and partitioning it into 8×8=64 areas (FIG. 3a(vii)). Finally, the mean intensities (i.e. shades of gray) of each area was calculated and represented as an 8×8 array numbered from 0 to 63 (FIG. 3a(viii)). This intensity array was the input to the visual PUF challenge-response protocol, which is described in FIG. 3b. The PUF challenge comprises 1536 bits (organized in 128 blocks of 12 bits each) while the response comprises 128 bits, where each response bit is obtained from its corresponding challenge block (FIG. 3b(i)). Computation of the PUF responses involves comparing the intensities of two areas a and b (denoted as Iₐ and I_{b}) selected from the 8×8 array (FIG. 3b (ii)). If Iₐ>I_{b}, the PUF response generated is 1; otherwise, it is 0. The indexes of the two areas to be compared are determined by the two components of 6 bits in each challenge block. Taking the 1^{st} challenge block—000111001101 for example, the first 6 bits (i.e. 000111) indicates the index of area a (which is 7 in decimal number) and the successive 6 bits (i.e. 001101) indicates the index of area b (which is 13 in decimal number). Since Iₐ=I₇>I_{b}=I₁₃, the 1^{st} PUF response for the 1^{st} challenge block is 1. Similarly, to generate the 128^{th} PUF response for the 128^{th} challenge block—000001100100, I₁ and I₃₆ were compared. Since I₁>I₃₆, the 128^{th} PUF response is also 1. Following this challenge-response protocol, a complete PUF response of 128 bits were calculated from a randomly generated challenge of 1536 bits for visual tags (FIG. 3b(iii)). The number of challenge blocks in this case can be chosen to be any integer in the range of 1 to 2016 based on customer needs.

### Performance of Silk MPs-Based PUFs.

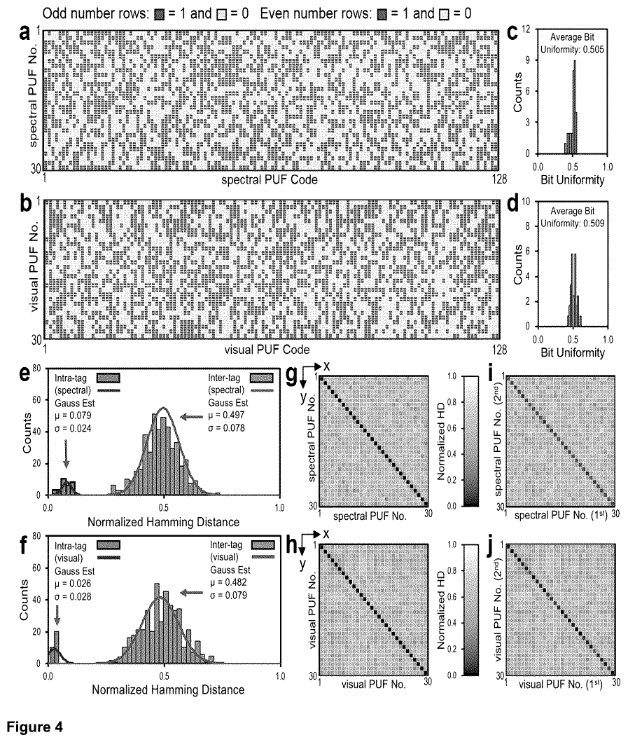

To ensure practical applicability of our silk MPs-based tags for PUF-based authentication, it is important to analyze their PUF codes using relevant metrics—bit uniformity, uniqueness, repeatability, and randomness (19, 46). Accordingly, PUF codes from 30 spectral tags (FIGS. 4a) and 30 visual tags (FIG. 4b) were repeatedly generated under the same challenge and statistically analyzed. Corresponding to each tag, its PUF codes are displayed in two rows with the top and bottom row representing the PUF code obtained from the 1^{st} (original) and 2^{nd} (repeated) measurement.

Bit uniformity is evaluated to verify that the PUF code is not biased towards either bit 0 or 1. Mathematically, bit uniformity is defined as the probability of observing the digit 1 in a binary code P:

$$Bit uniformity ( P ) = \frac{1}{L} {\sum }_{i = 1}^{L} {P}_{i} \qquad ( 1 )$$

where L is the bit-length of the binary code P and Pᵢ is the i^{th} bit of P. Ideally, PUF codes should have an equal probability of digits 0 and 1, i.e. a bit uniformity value of 0.5. For both spectral and visual PUFs, histograms of their bit uniformity are plotted in FIGS. 4c and 4d, respectively, which show a very narrow distribution centered at 0.505 (for spectra PUFs) and 0.509 (for visual PUFs), thereby validating the good bit uniformity of our silk MPs-based PUFs.

Hamming distance (HD) is commonly used to study the uniqueness and repeatability of PUF codes (19, 46, 47). The HD between two binary codes P and Q is defined as the number of mismatched bits:

HD(P,Q)=Σᵢ₌₁^{L} (Pᵢ≠Qᵢ) (2)

where P and Q are both of length L bits, and Pᵢ and Qᵢ are the i^{th} bit of P and Q respectively. Therefore, HD ranges from 0 to L. If two PUF codes P and Q are identical, HD(P,Q)=0. For two uncorrelated bit sequences P and Q, HD(P,Q)˜0.5L, because statistically 50% of the bits in P and Q match.

Uniqueness evaluates whether each PUF code can be unambiguously identified. This is characterized by a metric known as inter-tag HD, defined as the HD between PUF codes obtained from two different tags under the same challenge. For a desirable PUF system, PUF codes obtained from different tags should be uncorrelated and therefore have an inter-tag HD of ˜0.5L. The PUF uniqueness is defined as the average of all inter-tag HDs and computed as below (19):

$$PUF uniqueness = \frac{2}{K ( K - 1 )} {\sum }_{x = 1}^{K - 1} {\sum }_{y = x + 1}^{K} \frac{H D ( {P}^{x} , {P}^{y} )}{L} \qquad ( 3 )$$

where K is the total number of tags, L is the bit-length of each PUF code, and P^{x} and P^{y} are the PUF codes obtained from the x^{th} and y^{th} tags under the same challenge, respectively. For 30 different tags (i.e., K=30), there are a total of 30×29/2=435 pairs of comparison, whose HDs were calculated, and the corresponding normalized HDs (i.e., HD/L) were plotted as histograms (shown in yellow bars) in FIG. 4e (for spectral PUFs) and FIG. 4f (for visual PUFs). The histograms of inter-tag HDs were well-fitted by Gaussian distributions, giving a mean (PUF uniqueness) of 0.497 and a standard deviation of 0.078 for the spectral PUFs, and a mean (PUF uniqueness) of 0.482 and a standard deviation of 0.079 for the visual PUFs. The uniqueness of these PUF codes is better elucidated in FIG. 4g (for spectral PUFs) and FIG. 4h (for visual PUFs), where the (x,y) position displays the HD(P^{x}, P^{y})/L. Good PUF uniqueness is indicated by the non-diagonal elements having colors that correspond to inter-tag HDs of ˜0.5. The clear color contrast between the diagonal and the non-diagonal elements also highlights the uniqueness of the PUF codes.

Repeatability assesses if the PUF codes obtained from the same tag are reproducible across different measurements. This is characterized by a metric known as intra-tag HD, which is defined as the HD between PUF codes obtained from the same tag under the same challenge across different measurements. For ideal PUFs, the intra-tag HD should be 0. To evaluate the PUF repeatability, each silk tag was read by the Raman spectrometer or the pocket microscope twice, producing two PUF codes from the two readouts under the same challenge. The PUF repeatability, defined as the average of all intra-tag HDs is computed as below (19):

$$PUF repeatability = \frac{1}{K} {\sum }_{x = 1}^{K} \frac{H D ( {P}^{x} , {R}^{x} )}{L} \qquad ( 4 )$$

where K is the total number of tags, L is the bit-length of each PUF code, and P^{x} and R^{x} are the 1^{st} (original) and 2^{nd} (repeated) PUF code obtained from the x^{th} tag under the same challenge, respectively. For 30 different tags, all the intra-tag HDs were calculated and their corresponding normalized HDs were plotted as histogram (shown in blue bars) in FIG. 4e (for spectral PUFs) and FIG. 4f (for visual PUFs). Histograms of the intra-tag HDs were again fitted by Gaussian distributions, reporting a mean (PUF repeatability) of 0.079 and a standard deviation of 0.024 for the spectral PUFs, and a mean (PUF repeatability) of 0.026 and a standard deviation of 0.028 for the visual PUFs. The repeatability of these PUF codes is better elucidated in FIG. 4i (for spectral PUFs) and FIG. 4j (for visual PUFs), where the (x,y) position displays the HD(P^{x},R^{y})/L. Good PUF reproducibility is clearly seen by the diagonal elements having colors that correspond to intra-PUF HDs of ˜0. The clear color contrast between the diagonal and non-diagonal elements also corroborates that each silk tag can be repeatedly authenticated while retaining its uniqueness.

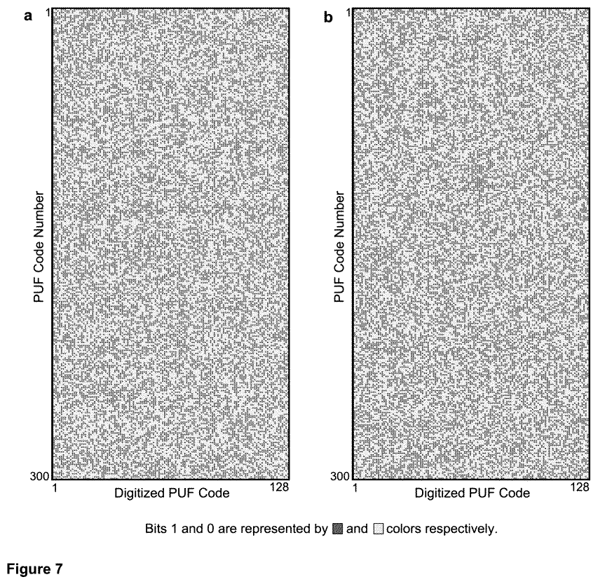

Finally, randomness ensures that each PUF code is a stochastic sequence and cannot be predicted without measuring the actual PUF (i.e., the silk MPs tag). Here we evaluate the randomness of the PUF codes extracted from our silk tags by using a statistical test suite developed by the National Institute of Standards and Technology (NIST) for assessing random number generators for cryptographic applications (48). The 128-bit PUF codes were evaluated using 8 tests from the NIST test suite. Each of the 8 NIST tests returns ap-value for each input PUF code which is considered as random with 99% confidence if its corresponding p-value≥0.01. In particular, each of the 30 spectral tags were challenged by 10 random sequences, generating 300 PUF codes (FIG. 7a) which were then submitted to the NIST test suite for assessment. For each of the 8 tests, Table 1 reports the averagep-value for all the 300 spectral PUF codes along with the pass rate (proportion of PUF codes that pass the corresponding test). The PUF codes are considered to have desirable randomness if the pass rate>95% (or equivalently>285/300) for each of the 8 tests. As shown in Table 1, the spectral PUF codes successfully passed all the randomness tests. The same randomness tests were also performed on 300 codes from the visual PUFs (FIG. 7b), and the results of which were summarized in Table 2. Together, we verified the randomness/unpredictability of our silk MPs-based PUFs.

### Discussion

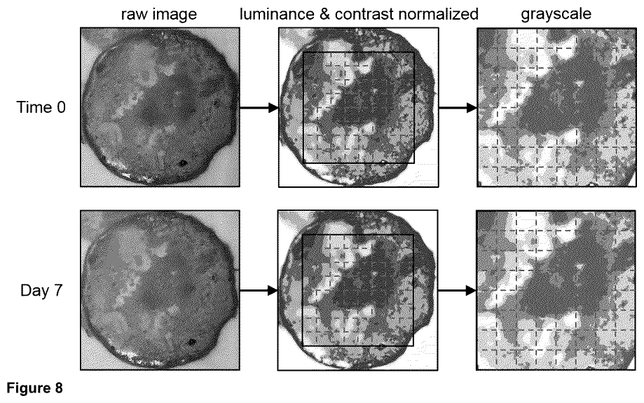

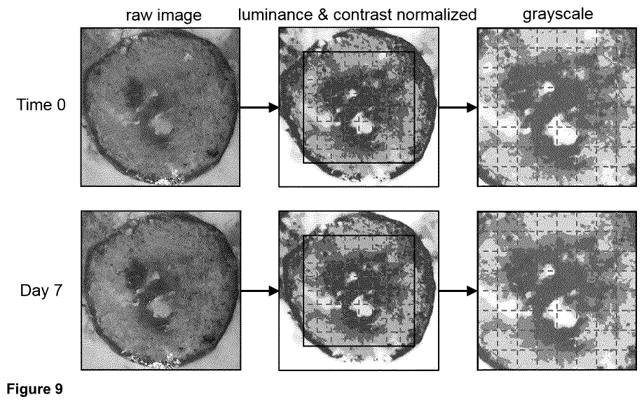

Although amorphous silk (i.e. silk molecules in random coils dominated conformations) are susceptible to a few environmental factors such as humidity and temperature, it is noted that highly crystalline silk (i.e. silk molecules folded in highly ordered structures including but not limited to β-sheets, β-turns and α-helix) are not. As all the silk MPs used to make the PUF tags are composed of highly crystalline silk obtained through either templated crystallization or water annealing to full strength, we believe that our silk MPs-based PUF tags are stable against all environmental factors that might occur during seed storage and transportation over a long period of time. This claim is supported by the repeatability data presented in FIG. 4 where the 2^{nd} measurements of all PUF tags were conducted after storing the tagged seeds for 3 months at room temperature and ambient humidity (i.e., 23° C. and 25-40% relative humidity in a typical spring period in Boston, US). Furthermore, we conducted stability and repeatability evaluation of the silk MPs tags stored under extreme humidity (75% RH) and extreme temperature (50° C.) for 7 days (FIGS. 8-9). Spectral tags stored at elevated humidity (75% RH) alone and a combination of elevated temperature and humidity (50° C. and 75% RH) show almost identical Raman spectra before and after being stored at corresponding conditions for 7 days, verifying that neither humidity nor temperature within the feasible range of seed storage conditions have an effect on silk conformation and repeatability of the spectral tags, due to the fact that they are composed of highly crystalline silk MPs. The same conclusion also applies to visual tags, which show no observable changes before and after being stored at the same humidity and temperature conditions, therefore their PUF codes can be repeatedly verified (FIG. 8-9).

It is also important to note that biodegradability does not indicate reduced reliability or increased instability of the silk MPs tag. Silk can be degraded by certain enzymes (e.g. protease XIV and α-chymotrypsin), soil microbes and in marine environment, and the degradation rates vary from days to years depending on the crystallinity of silk. As such, silk is considered as a biodegradable material, which we believe is an advantage as compared to non-biodegradable materials such as gold nanoparticles and certain plastics which have been used in making PUFs. However, those factors that can degrade silk (i.e. enzymes and microbes) do not exist during normal seed storage and transportation. If anything, we have found that the seeds themselves are more prone to damage than the silk tags, due to improper storage conditions.

For practical applications, we envision that the proportion of seeds being labeled with PUF tags will vary depending on seed type, seed value and the amount of seeds sold in a batch etc. For high-end products like a special breed of tulip bulbs, one may choose to label each bulb with a unique PUF tag; while for seeds sold in large volumes such as rice seeds, labeling a small portion of seeds randomly picked from a whole batch (e.g. 10 out of 1000 seeds in a bag) should be sufficient for authentication of the entire bag of seeds. Here we demonstrate the capability of labeling individual seeds regardless of their size, shape and surface texture, but this does not imply the necessity to do so in every situation.

When it comes to scanning of the spectral PUF tags, admittedly most Raman spectrometers are not readily accessible to farmers and general customers at the moment. However, as the field of portable Raman advances which features rapid miniaturization and lower cost of the spectrometers as well as shorter acquisition time for each spectrum (51-53), it is certainly not a dream that Raman spectrometers will be widely used in Agriculture one day. As a matter of fact, there are already many successful examples where handheld Raman spectrometers were developed for Agri-Food applications such as non-destructive monitoring of plant stresses in the field (54-56). As for verification of the visual PUF tags, the pocket microscope used in this study is inexpensively available from various commercial sources. With a resolution of 1920×1080 pixels, the pocket microscope can be conveniently connected to a smartphone via its built-in Wi-Fi function, so that anyone with a smartphone will be able to scan the visual tags and save the captured tag images in their smartphone within seconds.

### Conclusion

To summarize, we developed a cryptographic protocol for seed authentication using biopolymer-based PUF tags that can be conformably attached to a variety of seeds. Silk MPs of variant polymorphs were fabricated through templated crystallization of silk on different peptide seeds and spray drying of silk followed by water annealing, which serve as the building blocks of our PUF tags. By drop casting a mixture of variant silk MPs and amorphous silk on a seed surface, a tamper-evident PUF tag was seamlessly attached to the seeds, where the unclonability comes from the stochastic assembly of spectrally distinct silk MPs in the tag. PUF codes of 128 bits were generated based on the intrinsic variations in the Raman spectrum features across different areas of the silk tag. The encoding capability of our silk MPs-based PUF can be easily scaled by adjusting the challenge length. Alternatively, addition of colored salts (e.g. FeCl₃) to the silk MPs suspension enables fabrication of a visual PUF whose intrinsic entropy comes from the random distribution of colored silk-iron MPs in the tag. These visual PUFs can be conveniently read by a portable, inexpensive microscope and then processed for computing the PUF responses. Uniqueness, readout reproducibility and randomness of the silk MPs-based PUFs were also verified by performing standard statistical analyses. These results further guarantee the robustness of our silk MPs-based tags as PUF devices, thus highlighting their applicability as anticounterfeiting labels in real-life scenarios.

### Materials and Methods

Peptide synthesis. All the peptides used in this study were synthesized by GenScript (Piscataway, N.J.), with free N- and C termini. In brief, peptides were synthetized using standard Fluorenylmethyloxycarbonyl (Fmoc)-based solid-phase peptide synthesis and purified by reverse-phase high-performance liquid chromatography to a purity of 95% or higher. All peptides were dissolved in pure Milli-Q™ water.

Silk fibroin regeneration. Silk fibroin was extracted from Bombyx mori cocoons following established protocols (57). In brief, chopped silk cocoons were degummed in a boiling 0.02 M sodium carbonate solution for 30 minutes to remove the sericin. The obtained silk fibers were then washed with Milli-Q™ water for several times followed by overnight drying. The dried silk fibers were dissolved in 9.3 M lithium bromide at 60° C. for 4 hours followed by dialysis against Milli-Q™ water for 2 days with constant changing of water. The resulting silk fibroin solution was then purified by two centrifugation cycles at 20,000×g for 30 minutes each, yielding a final silk fibroin solution of ˜7 wt %. The regenerated silk fibroin solution was then stored at 4° C. until use.

### Preparation of Silk Microparticles (MPs).

Preparation of silk MPs #1. Spray drying was performed using a Model SD-18A Lab mini spray dryer (Labfreez Instruments, China). Under compressed air from an oil-free air compressor (˜100 psi), silk fibroin solution at 2 wt % was atomized through a two-fluid nozzle (0.7 mm diameter). The atomizing air flow was adjusted with a flow meter to reach a typical flow rate of 30 L/min. The silk fibroin solution was fed to the nozzle by a peristaltic pump with a liquid feed rate of 3.33 mL/min. The inlet air temperature was set at 150-155° C. and the dry air flow rate was 1000 L/min, which resulted in the outlet air temperature being 75-80° C. Silk microparticles collected after spray drying were put in a humidified chamber (with a relative humidity of >90%) and incubated for 24 hours. This process is referred to as the water annealing process (35), which induces formation of silk I structures and renders the water-annealed silk microparticles water-insoluble.

Preparation of silk MPs #2,3,4. To prepare silk MPs #2, silk fibroin solution at 5 mg/ml (i.e. 0.5 wt %) was well mixed with 5 mg/ml (GCGAGA)₂ (SEQ ID NO:20) at a volume ratio of 1:1. After letting the mixture age for 48 hours, the solution was frozen at −80° C. for 12 hours followed by lyophilization at −105° C. and vacuum condition for 2 days with a freeze dryer. The lyophilized silk powders were then ground to finer particles by using a mortar and a pestle. Preparation of silk MPs #3 and #4 follows the same protocol, expect by changing the peptides used in templated crystallization to GAGAGSGAAS (SEQ ID NO:21) and HBSP, respectively.

Preparation of silk MPs suspension for PUF tag fabrication. Each of the four silk MPs was first suspended in water to a concentration of 1 wt %, followed by homogenization of the suspension through tip-sonication. Each silk MPs suspension was sonicated in an ice bath for 5 minutes with an amplitude of 30% (165 W output power) and pulse durations of lOs on-time and lOs off-time. Following sonication, the 1 wt % suspensions of four silk MPs were well mixed at a volume ratio of 2:1:1:1 by pipetting up and down. Regenerated silk fibroin solution at 1 wt % was then added to the mixed MPs suspension at a volume ratio of 3:7, generating a final solution made of 0.7 wt % (i.e. 7 mg/ml) silk MPs and 0.3 wt % (i.e. 3 mg/ml) amorphous silk molecules. To fabricate the PUF tags on seeds, 5 μL of the final solution was drop cast on each seed and air dried.

Effects of humidity and temperature on the stability of silk tags. Seeds labeled with both spectral and visual PUF tags were stored for 7 days in (1) a sealed container at room temperature (23° C.) with saturated NaCl solution to generate a constant relative humidity (RH) of 75% and (2) a sealed container at 50° C. with saturated NaCl solution to generate a constant RH of 75%. Each tag was measured by either Raman spectroscopy or pocket microscope before and after storage at corresponding conditions for 7 days, and compared to verify the stability of silk MPs tags against extreme humidity and temperature.

Raman mapping of the silk PUF tag. To allow for a defined readout site in each silk PUF tag, a 3×3 mm² mask with a cross-shaped window (0.6×0.6 mm² square with four arms of 0.2 mm length) was cut from an adhesive tape (3M (TC), 467 MP) by using a laser cutter. The mask was applied to each silk PUF tag on the seeds before Raman reading.

Raman mapping of a 90×90 μm² area within each silk PUF tag (centered at the origin of the mask window) was performed by using a Renishaw Invia™ Reflex Raman Confocal Microscope. A mapping resolution of 4×4 over the 90×90 μm² area was used throughout the study. All Raman spectra were collected over the Raman shift range of 715.8-1813.7 cm⁻¹ by using a 785 nm laser (100 mW power), a 100×objective (NA=0.90) and a reflectance grating of 1200 l/mm. Each Raman spectrum was acquired for a total of 30 s (accumulation of 15 spectra, each collected for 2 s).

### Characterization.

SEM imaging. The morphology of silk MPs and the microscopic view of the silk PUF tag on seeds were imaged with a Zeiss Gemini™ 450 SEM, under an acceleration voltage of 1 kV and a probe current of 80 pA. For imaging individual silk MPs, 10 μL of 0.1 wt % silk MPs suspension was drop cast on a silicon wafer and let it air dry, followed by imaging of the sample under SEM.

TEM imaging. Negatively stained TEM images were captured using a Tecnai G² Spirit TWIN microscope operated at 120 kV. For sample preparation, 5 μL of each peptide solution (typically at 0.1 mg/ml) was deposited on a glow discharged continuous-film carbon-coated copper grid (Electron Microscopy Sciences), wicked off after 2 mins, and then stained with 5 μL Nano-W™ (methylamine tungstate, Nanoprobes Inc.) for 1 min before being wicked off. The grid was then left to dry before imaging.

Dynamic Light Scattering (DLS). DLS measurements were performed on a Zetasizer™ Pro (Malvern Panalytical) under the non-invasive back scattering mode. Silk microparticles suspension diluted to 0.1 wt % was measured in a low-volume plastic UV cuvette (BrandTech™ BRAND™). The laser was at 633 nm and its power was adjusted automatically for different samples to an optimized range of counts by the built-in auto-attenuation capability. Measurement of each sample began after equilibration at 25° C. for 60 s and was repeated for 3 times to ensure good data repeatability.

Wide-Angle X-ray Scattering (WAXS). WAXS measurements were performed on a SAXSLAB instrument in transmission mode with a Dectris Pilatus3R™ 300 K detector set at a distance of 109.1 mm from the sample and a Rigaku 002 microfocus X-ray source producing Cu K_{α1} X-rays of wavelength 1.5409 Å. Samples were deposited on a thin mica window (5-7 μm thick) and dried before exposing to X-rays. The thin mica windows were chosen owing to its transparency to X-rays with no characteristic peaks in the scattering range of interest. Each spectrum was collected for 5 mins.

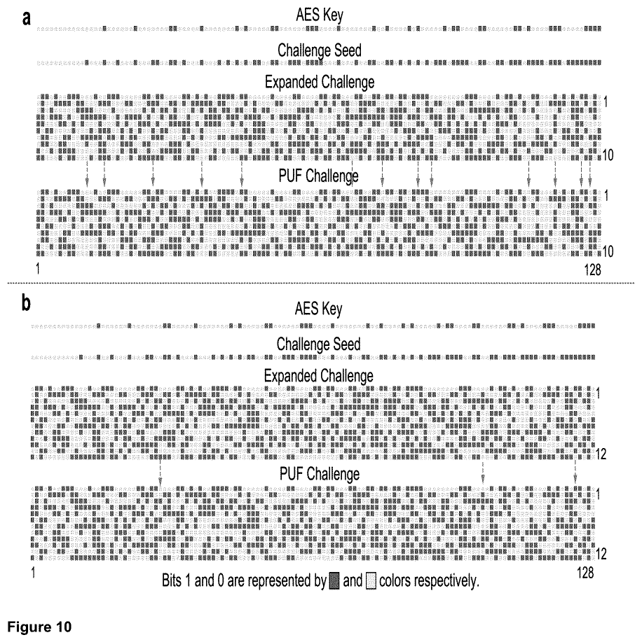

Generation of PUF Challenges. We used a cryptographically secure Pseudo Random Number Generator (PRNG) to generate random PUF challenges used for computing the PUF responses from our silk MPs-based tags. Our PRNG takes in a 128-bit seed sequence and then expands it by repeatedly encrypting it using the Advanced Encryption Standard (AES) cipher with a fixed key (FIG. 10) (58). For each encryption event, a sequence of 128 bits was generated, and the process was repeated for 10 times in the case of spectral PUFs (to obtain a PUF challenge of 1280 bits) and for 12 times in the case of visual PUFs (to obtain a PUF challenge of 1536 bits). We also did post-processing of the randomly generated challenge sequences to avoid meaningless comparisons. For example, each challenge block for a visual PUF comprises 12 bits that indicate the indexes of two areas a and b whose intensities (i.e. shades of gray) are to be compared. Thus, we need to ensure that a challenge block does not point to the same area (i.e., a≠b). In cases where such meaningless comparisons (i.e. a=b) were found, we flipped the lower 6 bits that correspond to the index of area b.

### REFERENCES

1. H. Nam, K. Song, D. Ha, T. Kim, Inkjet Printing Based Mono-layered Photonic Crystal Patterning for Anti-counterfeiting Structural Colors. Sci. Rep. 6, 1-9 (2016).
2. Y. T. Lu, S. Chi, Compact, reliable asymmetric optical configuration for cost-effective fabrication of multiplex dot matrix hologram in anti-counterfeiting applications. Optik (Stuttg). 114, 161-167 (2003).
3. S. P. McGrew, Holographic Technology for Anti-Counterfeit Security: Present and Future. Holo-pack & Holo-print Asia, Singapore (1996).
4. H.-J. Jeon, J. W. Leem, Y. Ji, S. M. Park, J. Park, K.-Y. Kim, S.-W. Kim, Y. L. Kim, Cyber-Physical Watermarking with Inkjet Edible Bioprinting. Adv. Funct. Mater. 32, 2112479 (2022).
5. S. Huang, J. K. Wu, Optical Watermarking for Printed Document Authentication. IEEE Trans. Inf. Forensics Secur. 2, 164-173 (2007).
6. F. Fayazpour, B. Lucas, N. Huyghebaert, K. Braeckmans, S. Derveaux, B. G. Stubbe, J.-P. Remon, J. Demeester, C. Vervaet, S. C. De Smedt, Digitally Encoded Drug Tablets to Combat Counterfeiting. Adv. Mater. 19, 3854-3858 (2007).
7. C. Huang, B. Lucas, C. Vervaet, K. Braeckmans, S. V. Calenbergh, I. Karalic, M. Vandewoestyne, D. Deforce, J. Demeester, S. C. De Smedt, Unbreakable Codes in Electrospun Fibers: Digitally Encoded Polymers to Stop Medicine Counterfeiting. Adv. Mater. 22, 2657-2662 (2010).
8. J. Lee, P. W. Bisso, R. L. Srinivas, J. J. Kim, A. J. Swiston, P. S. Doyle, Universal process-inert encoding architecture for polymer microparticles. Nat. Mater. 13, 524-529 (2014).
9. G. De Cremer, B. F. Sels, J.-I. Hotta, M. B. J. Roeffaers, E. Bartholomeeusen, E. Coutiño-Gonzalez, V. Valtchev, D. E. De Vos, T. Vosch, J. Hofkens, Optical Encoding of Silver Zeolite Microcarriers. Adv. Mater. 22, 957-960 (2010).
10. N. M. Sangeetha, P. Moutet, D. Lagarde, G. Sallen, B. Urbaszek, X. Marie, G. Viau, L. Ressier, 3D assembly of upconverting NaYF₄ nanocrystals by AFM nanoxerography: creation of anti-counterfeiting microtags. Nanoscale 5, 9587-9592 (2013).
11. S. Han, H. J. Bae, J. Kim, S. Shin, S.-E. Choi, S. H. Lee, S. Kwon, W. Park, Lithographically Encoded Polymer Microtaggant Using High-Capacity and Error-Correctable QR Code for Anti-Counterfeiting of Drugs. Adv. Mater. 24, 5924-5929 (2012).
12. T. K. Mackey, G. Nayyar, A review of existing and emerging digital technologies to combat the global trade in fake medicines. Expert Opin. Drug Saf 16,587-602 (2017).
13. D. Taylor, RFID in the Pharmaceutical Industry: Addressing Counterfeits with Technology. J. Med. Syst. 38, 1-5 (2014).
14. B. Gassend, D. Clarke, M. Van Dijk, S. Devadas, “Silicon Physical Random Functions” in Proceedings of the 9^{th} ACM Conference on Computer and Communications Security (ACM, 2002), pp. 148-160.
15. R. Pappu, B. Recht, J. Taylor, N. Gershenfeld, Physical One-Way Functions. Science 297(5589), 2026-2030 (2002).
16. G. E. Suh, S. Devadas, “Physical Unclonable Functions for Device Authentication and Secret Key Generation” in 44^{th} ACM/IEEE Design Automation Conference, (ACM/IEEE, 2007), pp. 9-14.
17. C. Herder, M.-D. Yu, F. Koushanfar, S. Devadas, Physical Unclonable Functions and Applications: A Tutorial. Proc. IEEE 102, 1126-1141 (2014).
18. Y. Gao, S.F. Al-Sarawi, D. Abbott, Physical unclonable functions. Nat. Electron. 3,81-91 (2020).
19. J. W. Leem, M. S. Kim, S. H. Choi, S.-R. Kim, S.-W. Kim, Y. M. Song, R. J. Young, Y. L. Kim, Edible unclonable functions. Nat. Commun. 11, 1-11 (2020).
20. Y. Gu, C. He, Y. Zhang, L. Lin, B. D. Thackray, J. Ye, Gap-enhanced Raman tags for physically unclonable anticounterfeiting labels. Nat. Commun. 11, 1-13 (2020).
21. M. S. Kim, G. J. Lee, J. W. Leem, S. Choi, Y. L. Kim, Y. M. Song, Revisiting silk: a lens-free optical physical unclonable function. Nat. Commun. 13, 1-12 (2022).
22. R. Arppe, T. J. Sorensen, Physical unclonable functions generated through chemical methods for anti-counterfeiting. Nat. Rev. Chem. 1, 1-13 (2017).
23. Y. Fan, C. Zhang, Z. Gao, W. Zhou, Y, Hou, Z. Zhou, J, Yao, Y. S. Zhao, Randomly Induced Phase Transformation in Silk Protein-Based Microlaser Arrays for Anticounterfeiting. Adv. Mater. 33, 2102586 (2021).
24. International Seed Federation, “Illegal seed practices—a threat to farmer livelihoods, food security and sustainable agriculture.” (2018).
25. Global Market Estimates, “EXECUTIVE SUMMARY—LOBAL COMMERCIAL SEED MARKET SIZE & ANALYSIS—FORECASTS TO 2026.” (2020).
26. World Bank, “Enabling the Business of Agriculture 2017.” (2017).
27. Alliance for a Green Revolution in Africa (AGRA), “Africa Agriculture Status Report: Focus on Staple Crops.” (2013).
28. World Health Organization, The State of Food Security and Nutrition in the World 2019: Safeguarding against economic slowdowns and downturns. (Food & Agriculture Org., 2019).
29. Access to Seeds Foundation, “Access to Seeds Index 2019—Eastern and Southern Africa.” (2019).
30. W. de Boef, O. Hasson, B. Pierson, D. Kim, J. Mennel, C. Engle, P. Prabhala, J. Bryce, N. Nemeth, A. Jethani, A. Hoffman, Counterfeiting in African Agriculture Inputs Challenges & Solutions: Comprehensive Findings. Gates Open Res 3, 250 (2019)
31. Y. Guan, J. Wang, Y. Tian, W. Hu, L. Zhu, S. Zhu, J. Hu, The Novel Approach to Enhance Seed Security: Dual Anti-Counterfeiting Methods Applied on Tobacco Pelleted Seeds. PLoS One 8, e57274 (2013).
32. S. Yigit, N. S. Hallaj, J. L. Sugarman, L. C. Chong, S. E. Roman, L. M. Abu-Taleb, R. E. Goodman, P. E. Johnson, A. M. Behrens, Toxicological assessment and food allergy of silk fibroin derived from Bombyx mori cocoons. Food Chem. Toxicol. 151, 112117 (2021).
33. H. Sun, Y. Cao, D. Kim, B. Marelli, Biomaterials Technology for AgroFood Resilience. Adv. Funct. Mater. 32, 2201930 (2022).
34. M. Liu, P.-E. Millard, H. Urch, O. Zeyons, D. Findley, R. Konradi, B. Marelli, Microencapsulation of High-Content Actives Using Biodegradable Silk Materials. Small 18, 2201487 (2022).
35. H.-J. Jin, J. Park, V. Karageorgiou, U.-J. Kim, R. Valluzzi, P. Cebe, D. L. Kaplan, Water-Stable Silk Films with Reduced β-Sheet Content. Adv. Funct. Mater. 15, 1241-1247 (2005).
36. Y.-F. Maa, P.-A. Nguyen, T. Sweeney, S. J. Shire, C. C. Hsu, Protein Inhalation Powders: Spray Drying vs Spray Freeze Drying. Pharm. Res. 16, 249-254 (1999).
37. H. Sun, B. Marelli, Polypeptide templating for designer hierarchical materials. Nat. Commun. 11, 1-13 (2020).
38. T. D. Sutherland, S. Weisman, A. A. Walker, S. T. Mudie, The Coiled Coil Silk of Bees, Ants, and Hornets. Biopolymers 97, 446-454 (2012).
39. W. H. Moore, S. Krimm, Vibrational Analysis of Peptides, Polypeptides, and Proteins. II. β-Poly (L-alanine) and β-Poly (L-alanylglycine). Biopolym. Orig. Res. Biomol. 15, 2465-2483 (1976).
40. P. Monti, P. Taddei, G. Freddi, T. Asakura, M. Tsukada, Raman spectroscopic characterization of Bombyx mori silk fibroin: Raman spectrum of Silk I. J. Raman Spectrosc. 32, 103-107 (2001).
41. M.-E. Rousseau, T. Lefevre, L. Beaulieu, T. Asakura, M. Pezolet, Study of Protein Conformation and Orientation in Silkworm and Spider Silk Fibers Using Raman Microspectroscopy. Biomacromolecules 5, 2247-2257 (2004).
42. N. Zahra, M. B. Hafeez, K. Shaukat, A. Wahid, M. Hasanuzzaman, Fe toxicity in plants: Impacts and remediation. Physiol. Plant. 173, 201-222 (2021).
43. C. Colombo, G. Palumbo, J.-Z. He, R. Pinton, S. Cesco, Review on iron availability in soil: interaction of Fe minerals, plants, and microbes. J. soils sediments 14, 538-548 (2014).
44. A. T. Zvinavashe, E. Lim, H. Sun, B. Marelli, A bioinspired approach to engineer seed microenvironment to boost germination and mitigate soil salinity. Proc. Natl. Acad. Sci. 116, 25555-25561 (2019).
45. R. E. W. Rafael, C. Gonzalez, Digital Image Processing. 4^{th} Ed. (Pearson, 2017).
46. M.-D. Yu, R. Sowell, A. Singh, D. M'Raïhi, S. Devadas, “Performance Metrics and Empirical Results of a PUF Cryptographic Key Generation ASIC.” in IEEE International Symposium on Hardware-Oriented Security and Trust, (IEEE, 2012), pp. 108-115.
47. V. Suresh, R. Kumar, M. Anders, H. Kaul, V. De, S. Mathew, “A 0.26% BER, 10²⁸ Challenge-Response Machine-Learning Resistant Strong-PUF in 14 nm CMOS Featuring Stability-Aware Adversarial Challenge Selection.” in IEEE Symposium on VLSI Circuits, (IEEE, 2020), pp. 1-2.
48. L. E. Bassham III, A. Rukhin, J. Soto, J. Nechvatal, M. Smid, E. Barker, S. Leigh, M.

Levenson, M. Vangel, D. Banks, A. Heckert, J. Dray, S. Vo, “A Statistical Test Suite for Random and Pseudorandom Number Generators for Cryptographic Applications.” (National Institute of Standards and Technology, 2010).
49. C. Guo, C. Li, D. L. Kaplan, Enzymatic Degradation of Bombyx mori Silk Materials: A Review. Biomacromolecules 21, 1678-1686 (2020).
50. A. T. Zvinavashe, Z. Barghouti, Y. Cao, H. Sun, D. Kim, M. Liu, E. J. Lim, B. Marelli, Degradation of Regenerated Silk Fibroin in Soil and Marine Environments. ACS Sustain. Chem. Eng. 10, 11088-11097 (2022).
51. W. S. Sutherland, J. P. Alarie, D. L. Stokes, T. Vo-Dinh, A Portable Surface-Enhanced Raman Spectrometer. Instrum. Sci. Technol. 22(3), 231-239 (1994).
52. A. K. Bandyopadhyay, N. Dilawar, A. Vijayakumar, D. Varandani, D. Singh, A low cost laser-Raman spectrometer. Bull. Mater. Sci. 21, 433-438 (1998).
53. M. A. Young, D. A. Stuart, O. Lyandres, M. R. Glucksberg, R. P. Van Duyne, Surface-enhanced Raman spectroscopy with a laser pointer light source and miniature spectrometer. Can. J. Chem. 82, 1435-1441 (2004).
54. T. T. S. Lew, R. Sarojam, I.-C. Jang, B. S. Park, N. I. Naqvi, M. H. Wong, G. P. Singh, R. J. Ram, O. Shoseyov, K. Saito, N.-H. Chua, M. S. Strano, Species-independent analytical tools for next-generation agriculture. Nat. Plants 6, 1408-1417 (2020).
55. S. Gupta, C. H. Huang, G. P. Singh, B. S. Park, N.-H. Chua, R. J. Ram, Portable Raman leaf-clip sensor for rapid detection of plant stress. Sci. Rep. 10, 1-10 (2020).
56. P. J. Chung, G. P. Singh, C.-H. Huang, S. Koyyappurath, J. S. Seo, H.-Z. Mao, P. Diloknawarit, R. J. Ram, R. Sarojam, N.-H. Chua, Rapid Detection and Quantification of Plant Innate Immunity Response Using Raman Spectroscopy. Front. Plant Sci. 12 (2021).
57. D. N. Rockwood, R. C. Preda, T. YUcel, X. Wang, M. L. Lovett, D. L. Kaplan, Materials fabrication from Bombyx mori silk fibroin. Nat. Protoc. 6, 1612-1631 (2011).
58. M. J. Dworkin, E. B. Barker, J. R. Nechvatal, J. Foti, L. E. Bassam, E. Roback, J. F. Dray Jr., “Advanced Encryption Standard (AES)” (National Institute of Standards and Technology, 2001.

TABLE 1
Results of the NIST Randomness Tests on
300 codes generated from 30 spectral PUFs

| Statistical Test | p-value | Accuracy | Result |
|---|---|---|---|
| Frequency | 0.4657 | 294/300 | Pass |
| Runs | 0.5067 | 298/300 | Pass |
| Longest Runs | 0.4791 | 300/300 | Pass |
| Serial | 0.5148 | 295/300 | Pass |
| | 0.4899 | 295/300 | |
| Approximate Entropy | 0.4859 | 295/300 | Pass |
| Cumulative Sums | 0.4999 | 298/300 | Pass |
| | 0.5076 | 300/300 | |

TABLE 2
Results of the NIST Randomness Tests on
300 codes generated from 30 visual PUFs

| Statistical Test | p-value | Accuracy | Result |
|---|---|---|---|
| Frequency | 0.4860 | 297/300 | Pass |
| Runs | 0.5121 | 296/300 | Pass |
| Longest Runs | 0.5126 | 297/300 | Pass |
| Serial | 0.5115 | 296/300 | Pass |
| | 0.4748 | 295/300 | |
| Approximate Entropy | 0.5087 | 297/300 | Pass |
| Cumulative Sums | 0.5420 | 298/300 | Pass |
| | 0.5455 | 299/300 | |

### Supporting Information Text

### Case Study of the Amount of Exogenous Iron Introduced to the Soil Through our Silk-Fe Seed Tags

The amount of exogenous iron added to the soil through the silk-Fe seed tags apparently depends on the amount of iron in each seed tag and the seed density (also known as seeding rate) in the soil. As the FeCl₃ concentration used in the seed tag fabrication is 50 mM, and each tag is formed from 10 μL of the silk-iron MPs suspension drop cast on a seed, the mass of iron in each seed tag is (56 g/mol)×(10×10⁻⁶ L)×(50×10⁻³ mol/L)=28 μg

Seeding is defined as the amount of seed of an individual species that is needed to achieve an adequate stand. Seeding rate is generally expressed in pure live seed (PLS) pounds per acre and is a predetermined number of live seeds per square foot to achieve a desired plant density (1). Although seeding rate is primarily determined by the plant species and its targeted stand for optimal yield, it is also influenced by many other factors, including for example seedbed conditions, row spacing, sowing depth, seed quality and time of sowing. According to a technical note from the United States Department of Agriculture (2), seeding rate have been established to be around 20-60 live seeds per square foot in order to achieve a desired plant density for most crop species. These seeding rates are fairly standard except when you are dealing with very large or very small seed sizes (e.g. eastern gamagrass vs. bermudagrass). Under those situations one may be looking at seeding rate as low as 2 seeds per square foot and as high as 240 seeds per square foot. For the purpose of this case study, we choose the extreme case of 240 seeds per square foot, which will give the highest amount of exogenous iron added to the soil from the seed tags.

For 240 seeds per square foot, this equals 2581 seeds per square meter. Setting the affected soil depth to be 1 meter and using a soil density of 1.3 g/cm³ (which is considered as representative for loamy soil (3)), this gives a number of 2581 seeds per 1300 kg of soil. As each seed tag contains 28 μg iron, 2581 seeds will add 2581×28≈72.3 mg iron to the 1300 kg soil surrounding them. Given that the typical range of iron concentration in cultivated soils is 20-40 g/kg (4), the exogenous iron introduced by the seed tags (which equals ˜56 μg iron per kg of soil) is ˜10⁶ orders of magnitude lower than the native iron contents in the soil. Therefore, we are confident that our silk-iron tags attached on the seeds cause little disturbance to the natural Fe dynamics in soil ecosystems.

Interpretation of the Parameters used in Digitization of Raman Readouts

Although there are a multitude of Raman peak features that can be used to digitize the Raman readouts from the spectral tags, four parameters were selected based on identification of the most significant variations in Raman spectra across different areas of the silk MPs tag. These four parameters are associated with different molecular vibrational modes as follows: (1) the band at 905 cm⁻¹ is a characteristic α-helical skeleton peak and the band around 960 cm⁻¹ relates to —CH₃ rocking and N—C^{α} stretching of poly-L-alanine domains folded in a α-helical conformation (5, 6); (2) the two peaks at 975 and 1005 cm⁻¹ are associated with the breathing modes of benzene rings in tyrosine and phenylalanine, respectively (7, 8); (3) the Amid III peaks at 1230 and 1265 cm⁻¹ originate mainly from N—H in-plane bending, C—C stretching, C—N stretching and C═O in-plane bending (9); and (4) the Amide I peak at 1665 cm⁻¹ corresponds largely to C═O stretching in β-sheet dominated conformations (6).

### SI References

1. D. Duvauchelle, “Understanding Pure Live Seed (PLS), Technical Note—PLANT MATERIALS—03” (2021).
2. M. J. Houck, “Understanding Seeding Rates, Recommended Planting Rates, and Pure Live Seed (PLS), Plant Materials Technical Note No. 11” (2009).
3. R. K. Rai, V. P. Singh, A. Upadhyay, “Chapter 17—Soil Analysis” in Planning and Evaluation of Irrigation Projects, 1st Ed. (Academic Press, 2017), pp. 505-523.
4. C. Colombo, G. Palumbo, J.-Z. He, R. Pinton, S. Cesco, Review on iron availability in soil: interaction of Fe minerals, plants, and microbes. J. soils sediments 14, 538-548 (2014).
5. B. G. Frushour, P. C. Painter, J. L. Koenig, Vibrational Spectra of Polypeptides. J. Macromol. Sci. Macromol. Chem. 15, 29-115 (1976).
6. M.-E. Rousseau, T. Lefèvre, L. Beaulieu, T. Asakura, M. Pézolet, Study of Protein Conformation and Orientation in Silkworm and Spider Silk Fibers Using Raman Microspectroscopy. Biomacromolecules 5, 2247-2257 (2004).
7. A. Sakamoto, M. Tasumi, Symmetry of the benzene ring and its normal vibrations: The “breathing” mode is not always a normal vibration of a benzene ring. J. Raman Spectrosc. 52, 2282-2291 (2021).
8. S. Contorno, R. E. Darienzo, R. Tannenbaum, Evaluation of aromatic amino acids as potential biomarkers in breast cancer by Raman spectroscopy analysis. Sci. Rep. 11, 1-9 (2021).
9. S. Krimm, J. Bandekar, Vibrational Spectroscopy and Conformation of Peptides, Polypeptides, and Proteins. Adv. Protein Chem. 38, 181-364 (1986).

1. A composition comprising a first product, wherein the first product comprises a physical unclonable function (PUF) tag comprising silk particles conformably and directly attached to the first product, wherein the PUF tag cannot be reattached to a second product once removed from the first product.

2. The composition of claim 1, wherein the first product comprises an agricultural product.

3. The composition of claim 2, wherein the agricultural product comprises seeds, tubers, bulbs, grains, seed coatings, and/or sprayable chemicals

4. (canceled)

5. The composition of claim 1, wherein the first product comprises a solid product for oral ingestion; a packaged product, wherein the PUF tag is conformably and directly attached to the package; or an injectable product.

6-9. (canceled)

10. The composition of claim 1, wherein the PUF tag is directly attached to the first product via non-covalent bonding.

11. The composition of claim 1, wherein the silk particles comprise microparticles and/or nanoparticles.

12. The composition of claim 1, wherein the PUF tag does not maintain its intactness and/or its adhesiveness when removed from the first product.

13. The composition of claim 1, wherein the silk particles comprise silk fibroin having an average molecular weight of between about 5 kD and about 400 kD.

14. The composition of claim 1, wherein the silk particles comprise or consist of crystalline silk.

15. The composition of claim 1, wherein the PUF is biodegradable, and/or is edible.

16. The composition of claim 1, comprising a plurality of the first products.

17. The composition of claim 16, wherein the composition further comprises additional first products that do not comprise a PUF tag.

18. The composition of claim 16, wherein the plurality of first products comprise a plurality of molecularly distinct PUF tags comprising different silk polymorphs.

19. The composition of claim 16, wherein the plurality of molecularly distinct PUF tags comprise colored inorganics having random and visually distinct patterns in the plurality of PUF tags.

20. The composition of claim 19, wherein the colored inorganics are selected from the group consisting of colored salts, pigments, particles of photonic crystals, and/or colored microparticles, and combinations thereof.

21. The composition of claim 16, wherein the plurality of PUF tags have distinct Raman spectroscopy spectra.

22. The composition of claim 16, wherein the silk particles comprise a marked region to standardize Raman mapping and/or optical imaging.

23. A method for preparing the composition of claim 1, comprising
(a) templated crystallization of silk fibroin into different polymorphs by mixing (i) a first solution of silk fibroin with (ii) a solution of peptides that possess the following properties: (i) capable of forming ordered supramolecular nanoassemblies; (iii) capable of binding to silk molecules through non-covalent interactions; and (iv) sharing a similar isoelectric point and pH stability to that of silk fibroin, to form a mixture;
(b) incubating the mixture to form silk-peptide microparticles in the mixture;
(c) freeze-drying the mixture comprising silk-peptide microparticles to obtain lyophilized silk powders;
(d) grinding the silk powders to obtain silk microparticles;
(e) drop casting a suspension composed of the silk microparticles and amorphous silk molecules on the first products to form PUF tags conformably and directly attached to the first products.

24-29. (canceled)

30. A method for analyzing the composition of claim 1, comprising Raman mapping of a selected area in the PUF tag and generating a matrix of Raman spectra.

31-38. (canceled)

39. A method for analyzing the composition of any preceding claim 1 wherein the PUF tags comprise colored silk-inorganics exhibiting random and visually distinct patterns, comprising detecting the random and distinct visual patterns.

40-48. (canceled)
